(19) United States
(12) Patent Application Publication
(10) Pub. No.: US 2013/0325878 A1
(43) Pub. Date: Dec. 5, 2013

(54) COMMUNITY PLANNING SYSTEM WITH SENSORS AND SOCIAL MEDIA

(71) Applicant: Daniel de Lichana, Verrieres Le Buisson (FR)

(72) Inventor: Daniel de Lichana, Verrieres Le Buisson (FR)

(21) Appl. No.: 13/910,864

(22) Filed: Jun. 5, 2013

Related U.S. Application Data
(60) Provisional application No. 61/655,877, filed on Jun. 5, 2012.

(51) Int. Cl. G06F 17/30

(52) U.S. Cl. CPC G06F 17/30312
USPC 707/748

(57) ABSTRACT

An interactive, computerized system for community planning includes one or more databases storing a computer-generated community plan and supporting data associated with a geographical area. The system includes sensors providing data related to the geographical area, and a feedback module configured to receive feedback from a plurality of persons or entities associated with the geographical area or the community plan. The feedback may comprise social media activity data collected from one or more social media outlets. The system includes a scoring module to determine scores related to criteria associated with the community plan based upon the sensor data and the activity data. The system is configured to utilize the scores in the development, implementation, maintenance, or control of the community plan. The system includes a notification module to transmit or display a notification upon the occurrence of a suggested change to the community plan or a trade specification.

### CROSS REFERENCE TO RELATED APPLICATIONS

This application claims priority from U.S. Provisional Patent Appl. No. 61/655,877 filed on Jun. 5, 2012 by the same inventor, which is incorporated herein by reference in its entirety. This application is also related to U.S. patent application Ser. No. 10/617,829 filed on Jul. 14, 2003 by the same inventor (published as U.S. Patent Pub. No. 2004/0117777 A1), which is also incorporated herein by reference in its entirety.

### TECHNICAL FIELD

The technical field is land-use development and management.

### BACKGROUND

Our urban/suburban and rural landscape initially was a mosaic of the components of our daily life. Yet in the 20th century the separation between the functions of “life,” “work,” and “play” has been prevalent. This modification in our approach to land use has had a perverse effect on the evolution of our towns, suburbs, and country side. The resulting urban/suburban/rural land use problems have been treated mostly through a mono-disciplinary approach. Land-use planning has been mostly through zoning (e.g., offices, individual or collective habitat, recreational, inexpensive or luxurious) influenced by this separation of function. The value of a site as determined by the type of land use has also been influenced by this separation of functions.

The new urbanism movement that began at the end of the 20th century has reintegrated the traditional vision that includes all the components of our daily life within the sphere of a determined site. The evolution of population and economic growth in the developing countries also participates in the development and creation of new cities. According to the Illinois Institute of Technology International Center for Sustainable New Cities, “China alone is said to have over 100 new cities now being built or planned. . . . India, whose population is expected to surpass China's by the year 2050, is not far behind China in its planned economic development and urban population demands.”

The interaction between human and technological evolution is at the root of our civilizations. Our way of life is a reflection of this interaction and our landscape must offer the flexibility to integrate harmoniously social, cultural, ethical and technological evolutions in a secured, high-performance system. A multifunction approach to land use is needed. It is an object to have an improved community planning system. It is an object to have a system that is more responsive and reactive to the public with which to implement, manage and/or maintain a community plan. It is an object to have a planning and plan management system that is more responsive and reactive to users, communities, service providers, developers and investors. It is another object to have a more dynamic system for implementation of existing plans, managing and/or maintaining a community plan. It is also an object to optimize the balance between the different elements of the urban planning process inasmuch as they relate to surrounding neighborhoods, cities, regions, states. In the global context, it is important to resolve trans-border issues, such as water, pollution, energy, security, health etc. It is also an object to address these geopolitical elements.

### SUMMARY OF THE INVENTION

An interactive, computerized system for the development, conception, implementation, control, management and maintenance of a community plan is described for any community at whatever scale. The system includes a computer-accessible database, configured to store a computer-generated community plan associated with a geographical area, wherein data to support the plan is stored in a relational database and where the community plan is associated with a geographic area. The system further includes one or more sensors configured to provide sensor data related to the geographical area, and a feedback module configured to receive electronic communications comprising feedback from a plurality of persons or entities associated with at least one of the geographical area and the community plan. The system further includes a scoring module configured to determine scores related to one or more criteria associated with the community plan, wherein the scores are determined based upon the sensor data and the activity data, and wherein the system is configured to utilize the scores in the development, implementation, maintenance, or control of the community plan. The system further includes a system notification module, configured to transmit or display a notification upon the occurrence of a suggested change to the community plan.

The system may also include an improvement module configured to iteratively improve a score for one or more criteria, wherein the feedback module is further configured to solicit information from the public. The system may use the improvement module to iteratively improve the plan by successive rounds of collecting feedback and making modifications. The system may also include a trade specification generator (also known as a request for proposal (RFP) generator) configured to generate a trade specification based on the criteria scores determined by the scoring module, and wherein the system notification module is further configured to transmit or display a notification upon the generation of a new or revised trade specification.

In some embodiments, the system may further comprise one or more communication connections configured to receive sensor data from the one or more sensors. In some embodiments, the one or more sensors comprise four sensors selected from among the following types of sensors: audio, image, video, motion, visible light, infrared light, temperature, barometric, humidity, wind, seismic, vibration, explosive, radioactivity, chemical, water pressure, pipeline, spillage, fluid level, fluid flow, energy usage, and energy overload.

In one embodiment of the system, data is received from the sensors at least once a day and processed at least once a day for use in implementation, maintenance or control. In some embodiments, data is received from the sensors in real time.

In some embodiments, the one or more criteria associated with the plan include at least one of the land use, human, economic, environmental, geopolitical, political, governance, and geographic. In some embodiments, the one or more criteria comprise sub-criteria, and the scoring module is further configured to determine scores for the sub-criteria.

In some embodiments, the system may further comprise a social media interface configured to receive activity data from one or more social media outlets, and one or more communication connections configured to couple the social media interface to the one or more social media outlets.

In one embodiment of the system, the feedback module is connected to the social media interface and obtains social media activity. In some embodiments, the social media interface is further configured to determine one or more social media metrics based on the received activity data, and the scoring module is configured to utilize the social media metrics when determining scores. In some embodiments, the one or more social media metrics comprise one or more of volume per time unit, volume rate of change, reach, audience size, engagement, influence, conversation rate, sentiment, passion, strength, applause rate, and amplification.

In some embodiments, the social media interface is connected to the internet and gathers social media data. In some embodiments, the social media interface is configured to receive updates of the activity data at least once per day and to provide updates of the one or more social media metrics at least once per day. In some embodiments, the social media interface is further configured to receive real-time updates of the activity data and to provide real-time updates of the one or more social media metrics. In some embodiments, the feedback module is configured to receive real-time updates of the sensor data, and the scoring module is configured to update criteria scores in response to at least one of the updated sensor data and the updated social media metrics. In some embodiments, the system notification module is configured to generate real-time notifications in response to the updated criteria scores.

In some embodiments, the social media interface is configured to provide an interactive mapping application for soliciting information from the public related to at least one of the geographical area and the community plan. In some embodiments, the social media interface is configured to publish a request for public responses on at least one social media outlet, and to collect responses to the published request from the at least one social media outlet. In some embodiments, the social media outlets comprise one of more of Twitter, Facebook, Google Plus, blogs, YouTube, LinkedIn, MySpace, myLife, LiveJournal, Tagged, CafeMom, and Badoo.

Embodiments of the present disclosure also include methods for the management of a community plan associated with a geographical area, for use in a system according to one or more of the embodiments described above. Embodiments of the present disclosure also include computer-readable media embodying instructions executable by at least one processor comprising a community plan management system according to one of more of these methods.

### DRAWINGS

The detailed description will refer to the following drawings, wherein like numerals refer to like elements, and wherein:

FIG. 1 is a diagram of the high-level architecture of the community plan management system according to one or more embodiments of the present disclosure; and

FIGS. 2A-2V are diagrams illustrating the details of the four operational phases of the community plan management system according to one or more embodiments of the present disclosure.

### DETAILED DESCRIPTION

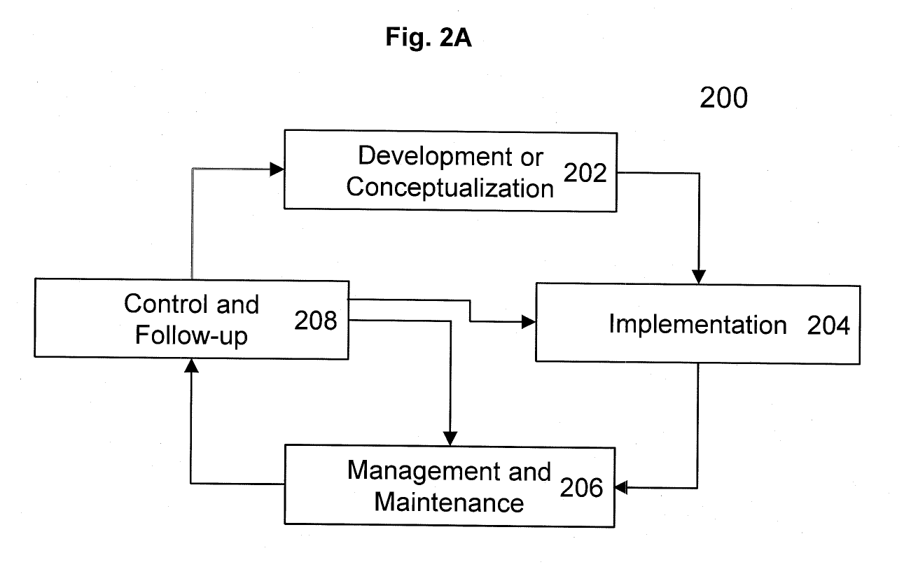

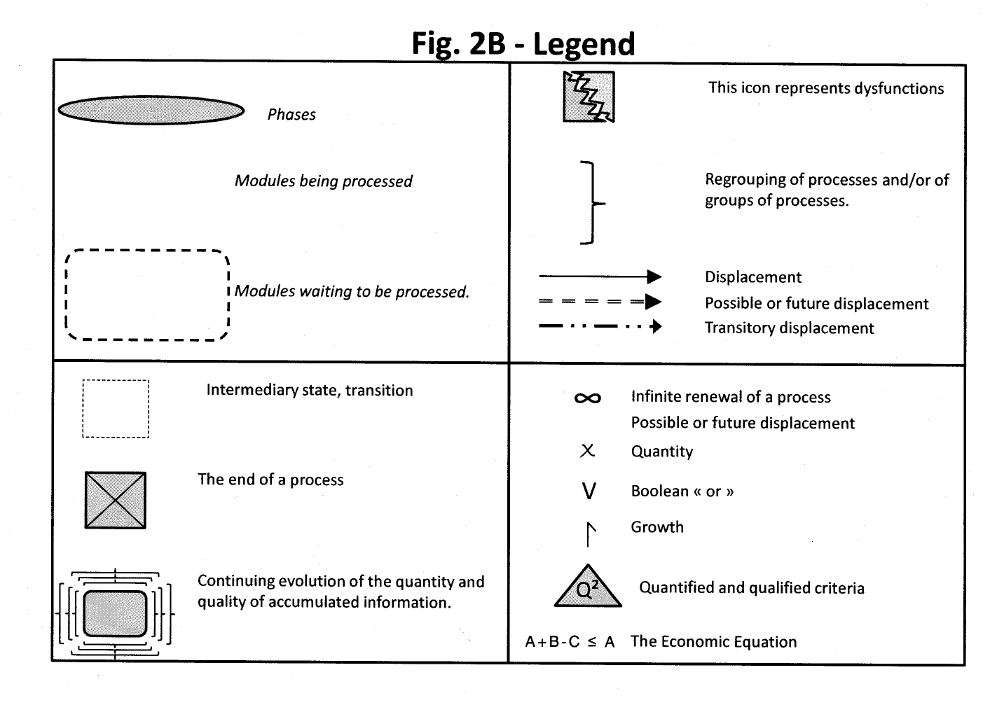

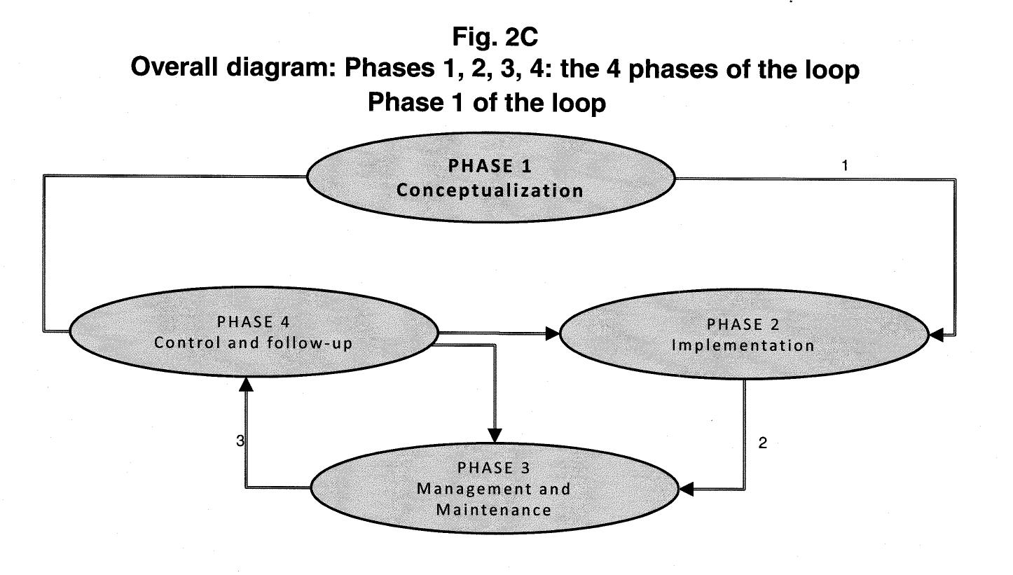

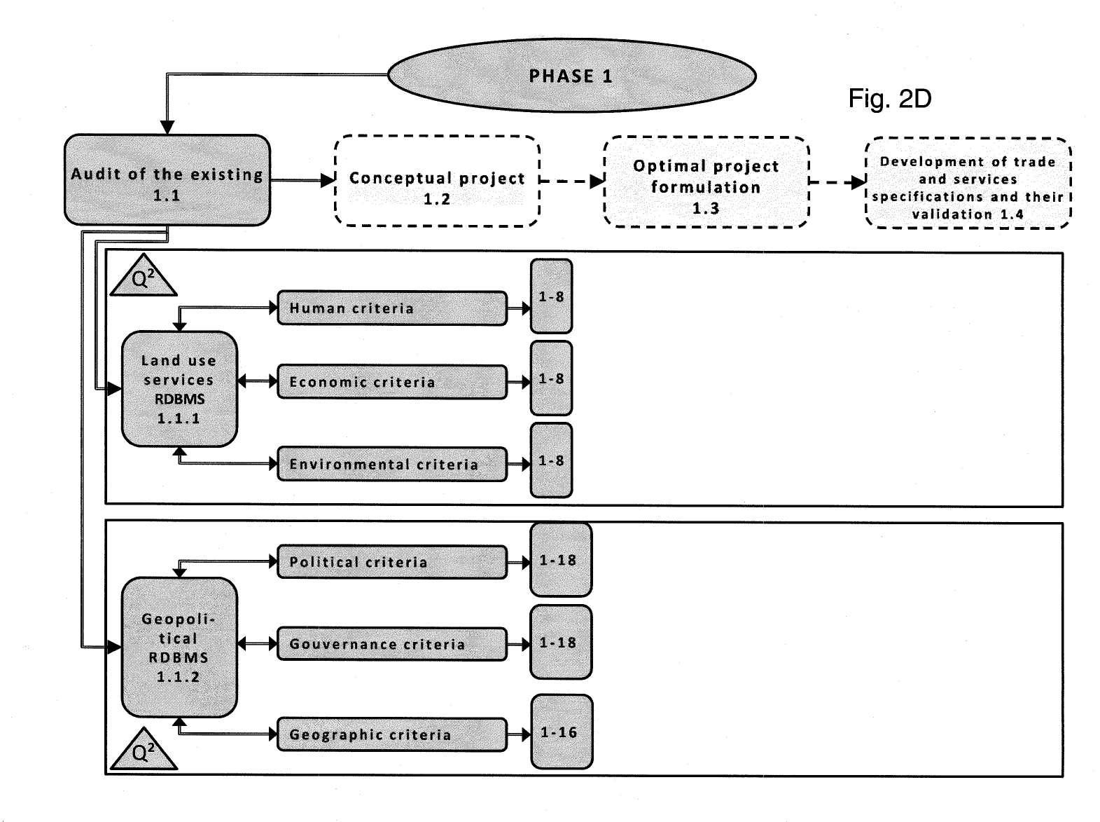

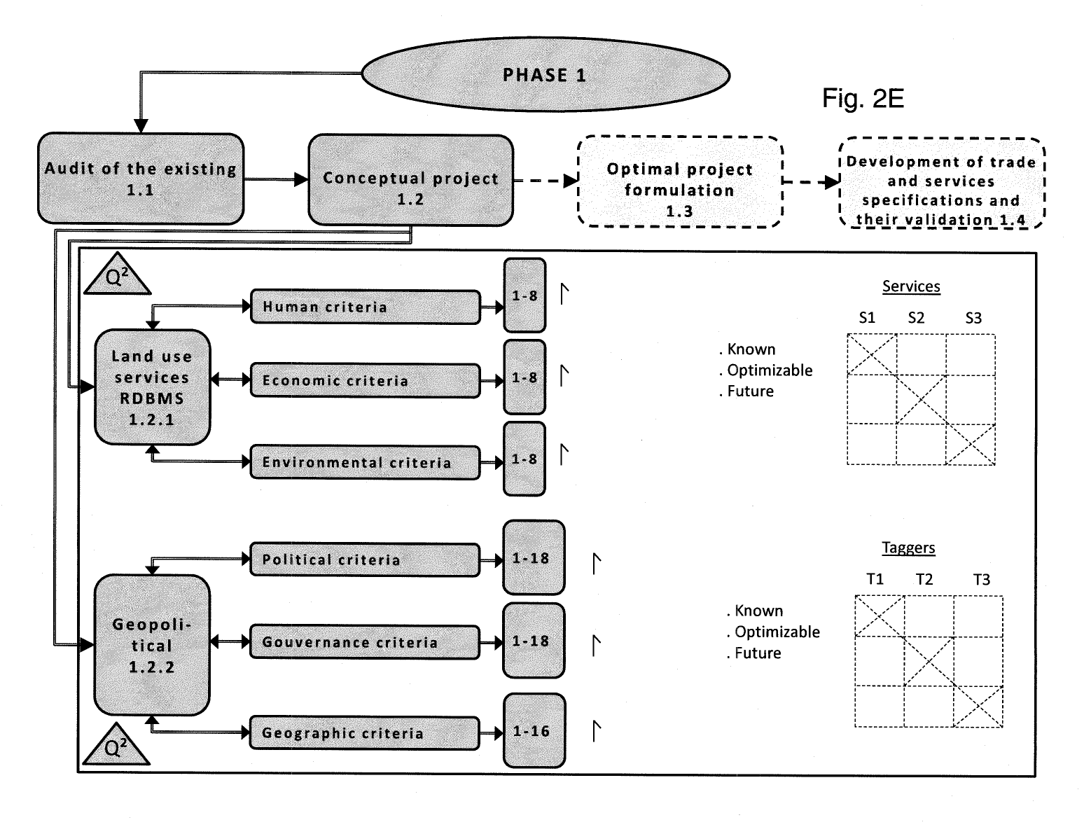

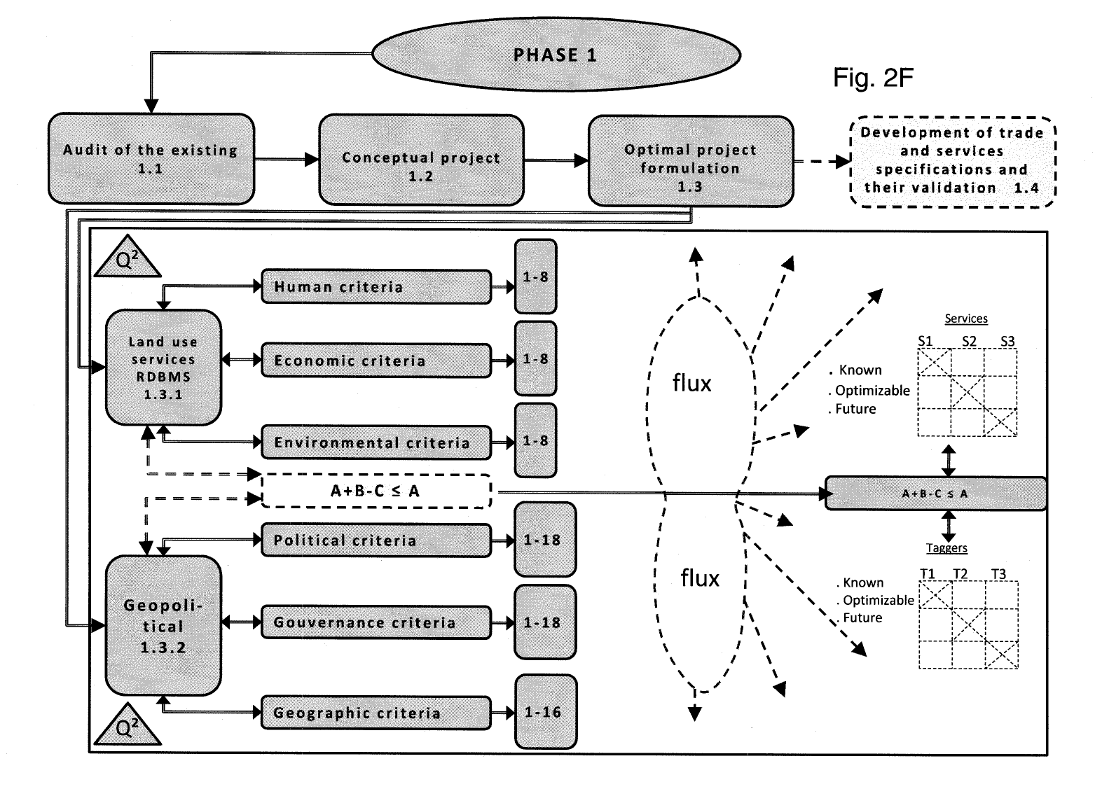

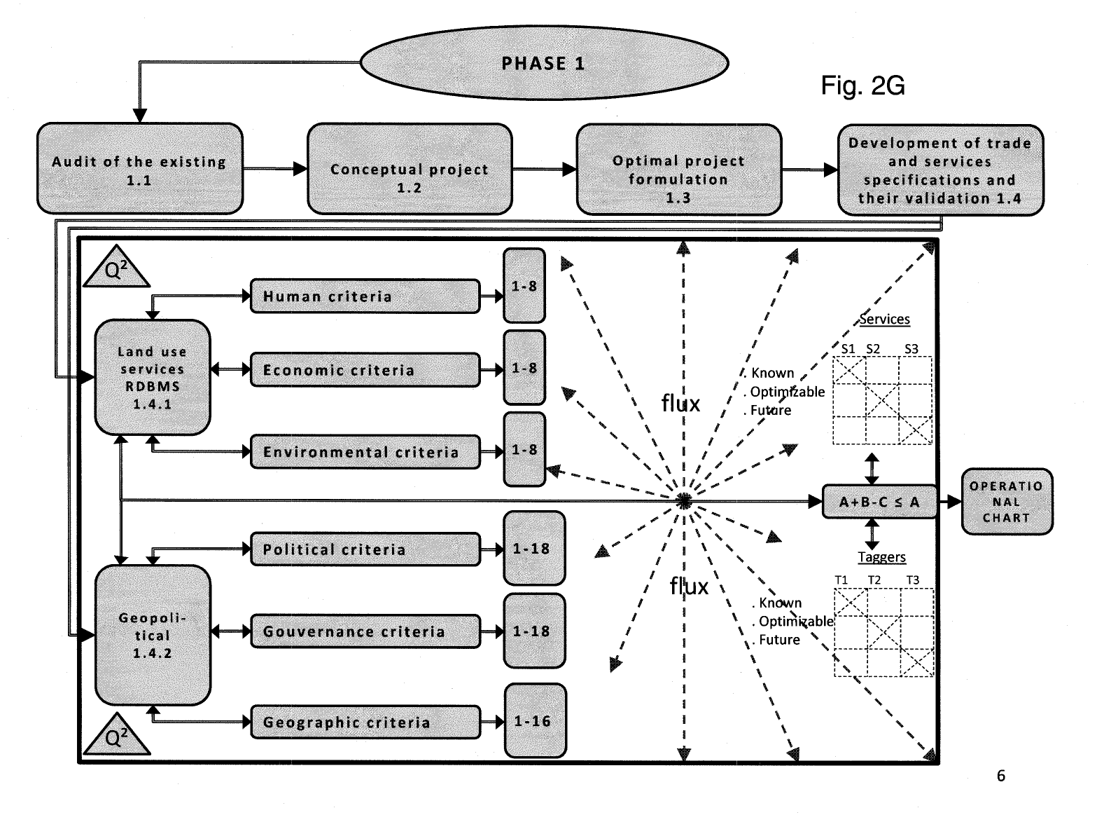

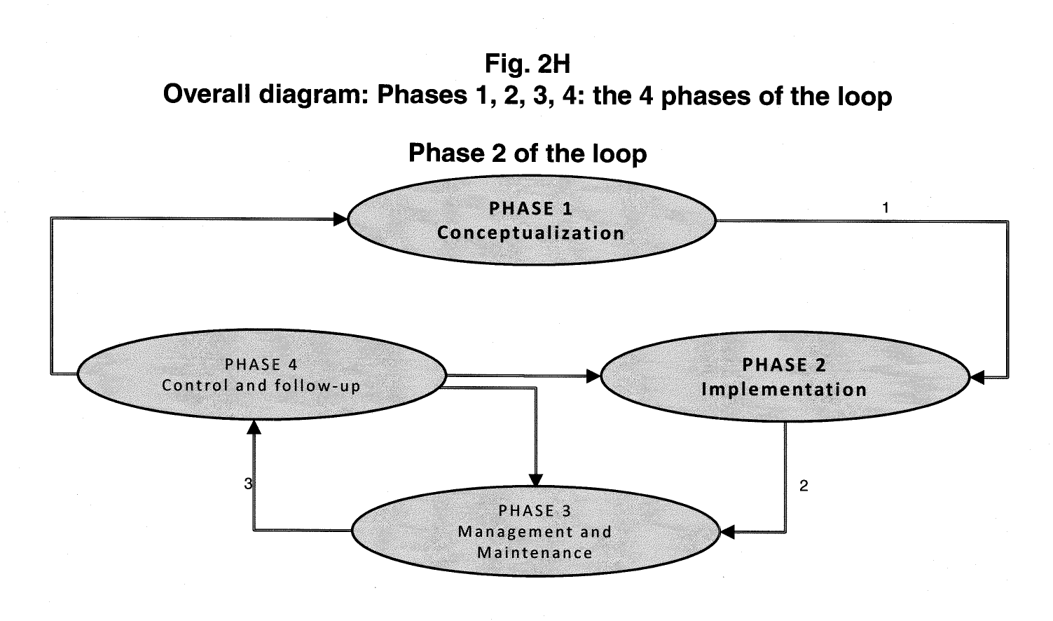

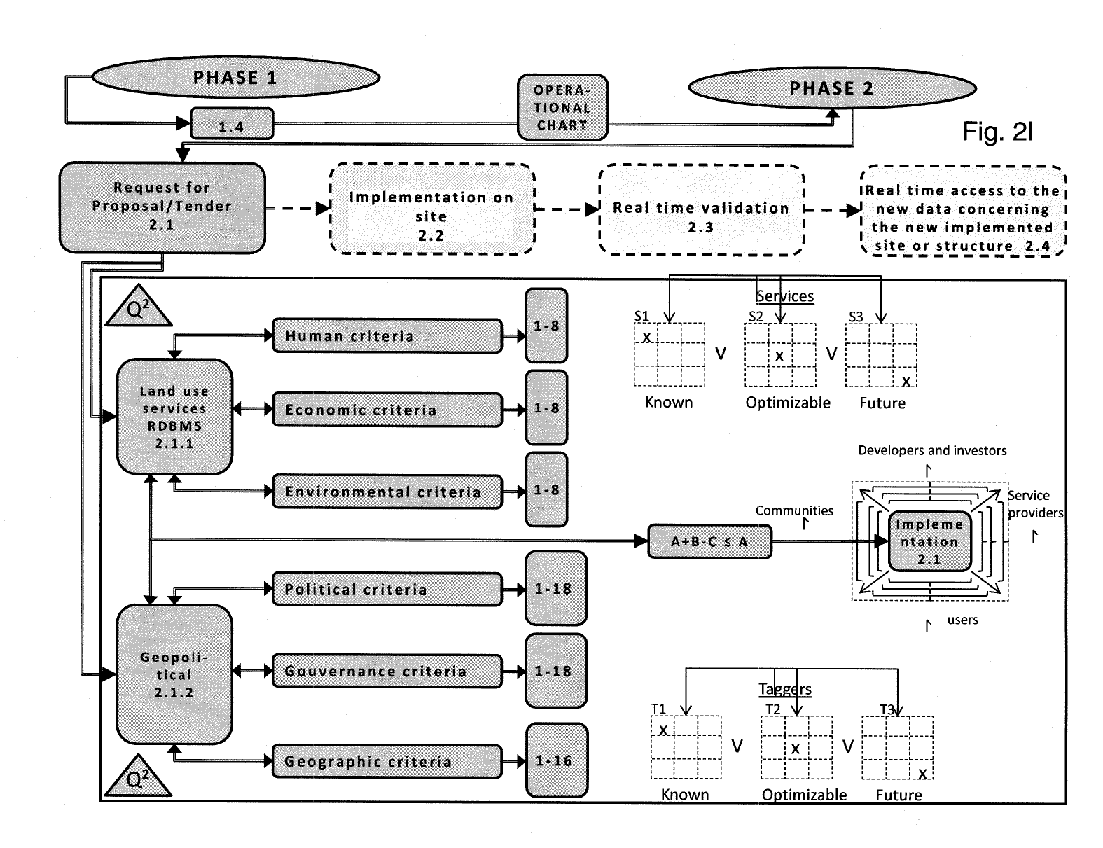

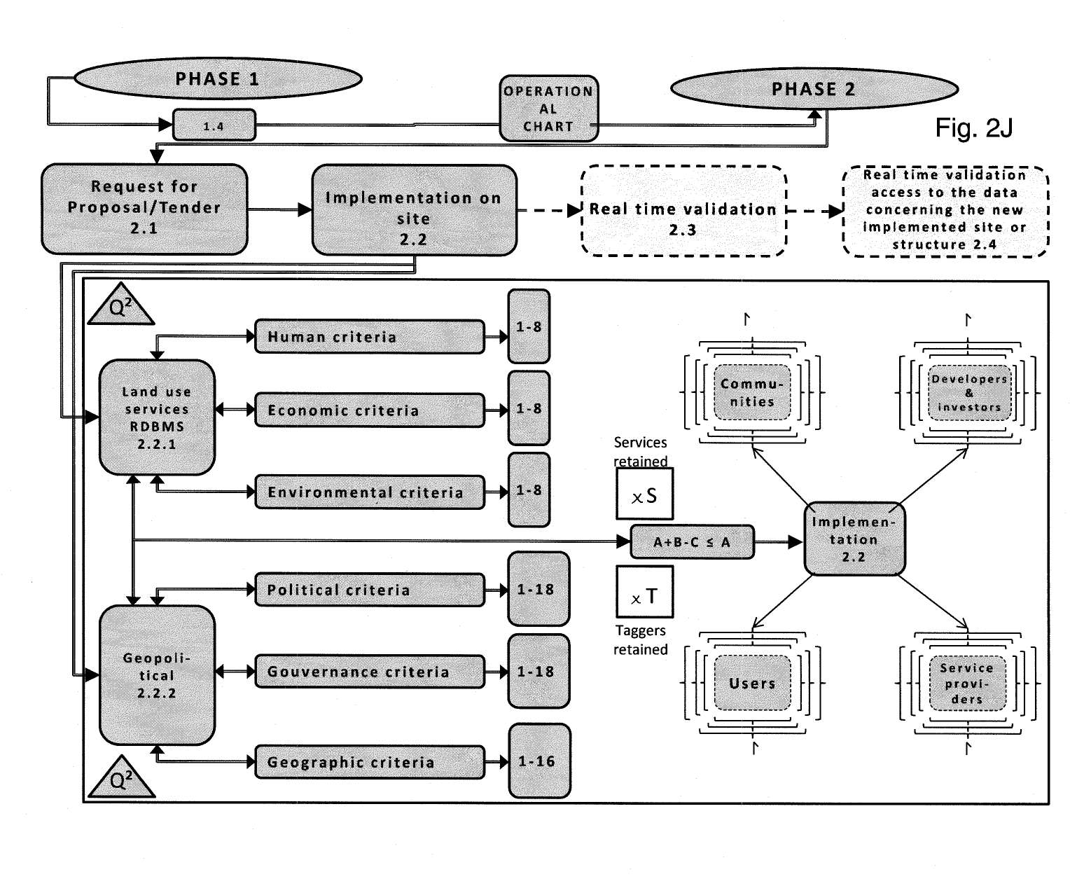

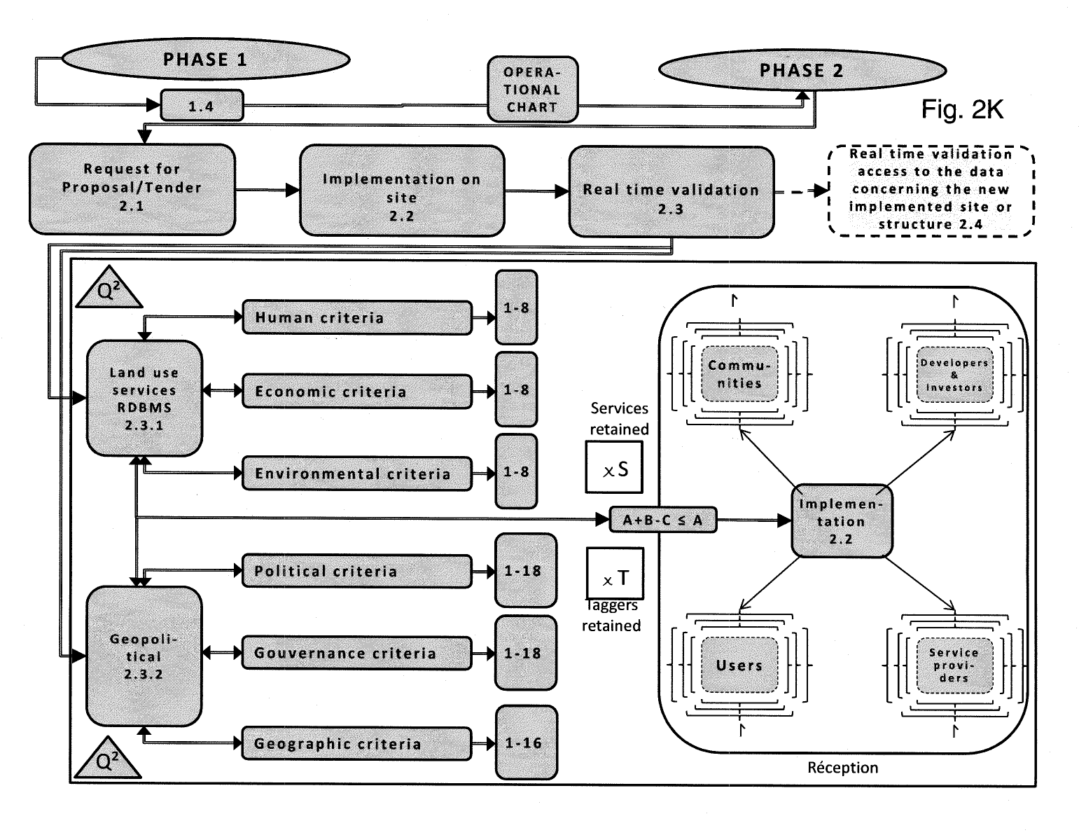

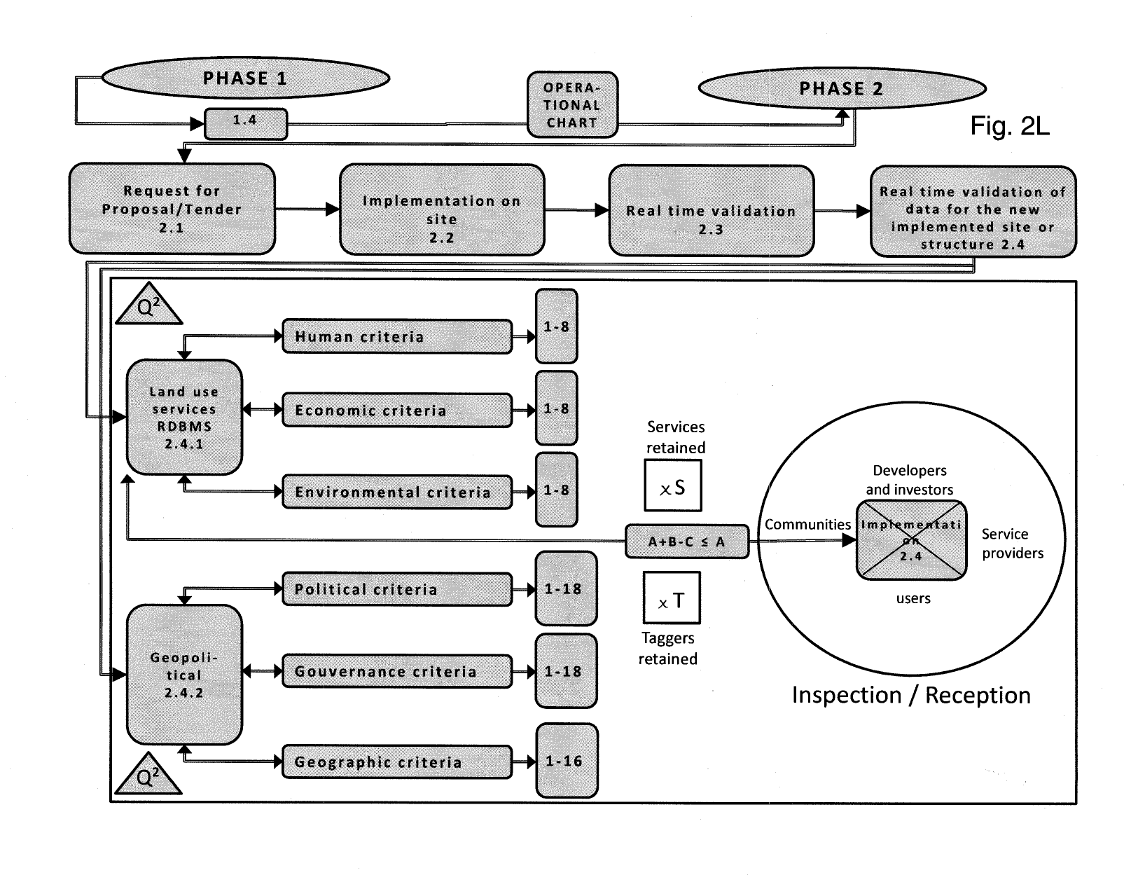

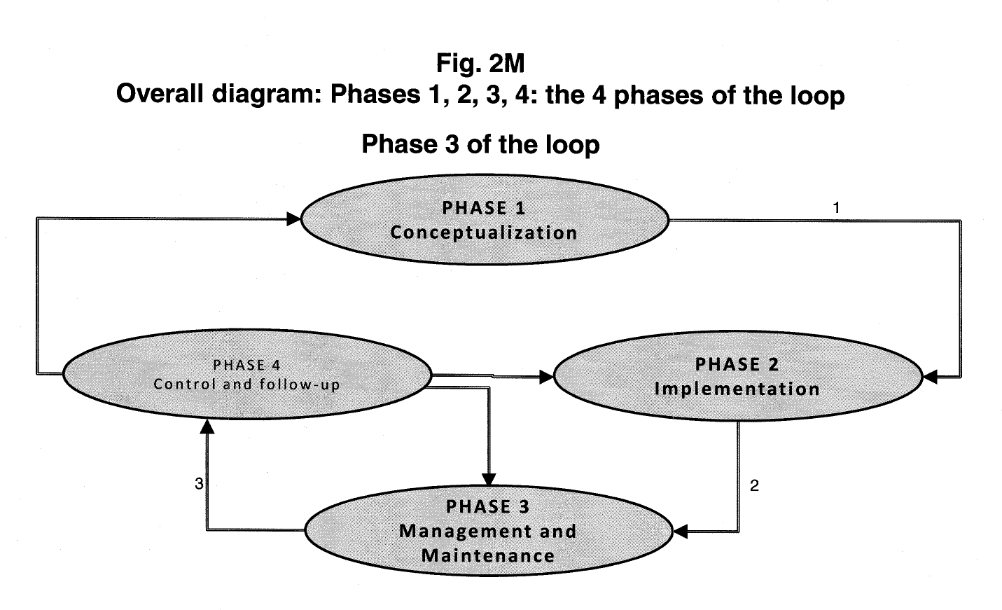

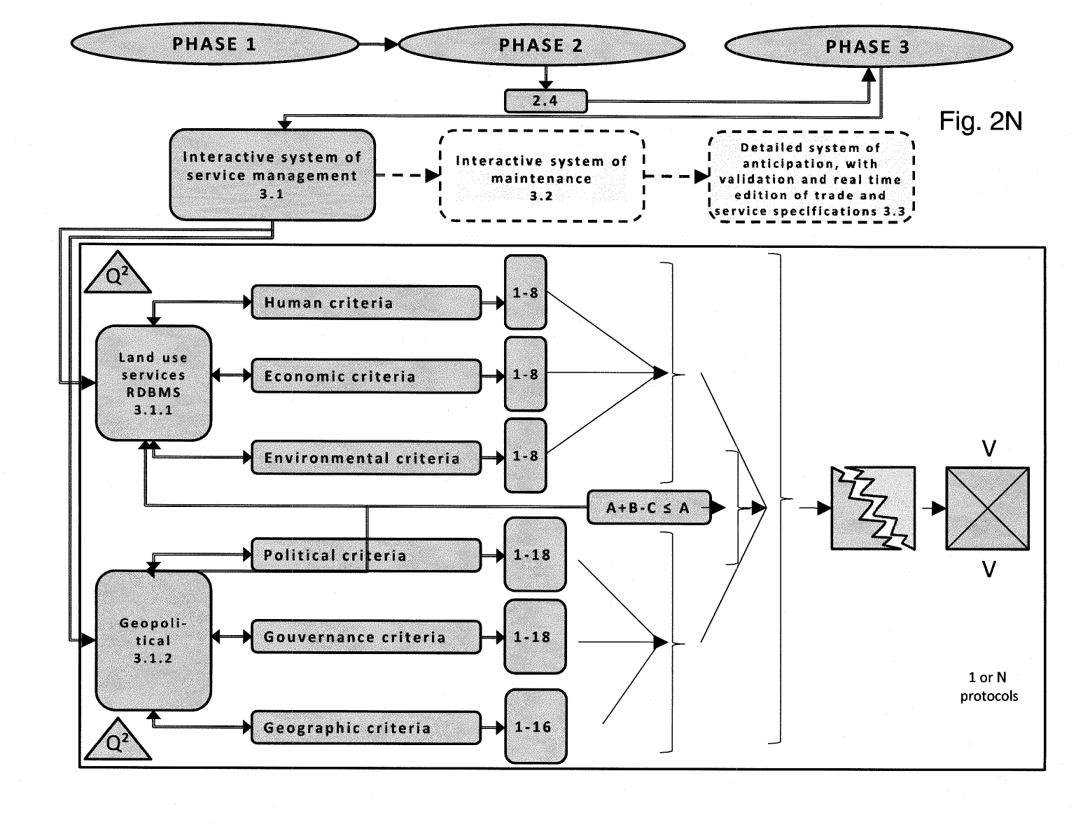

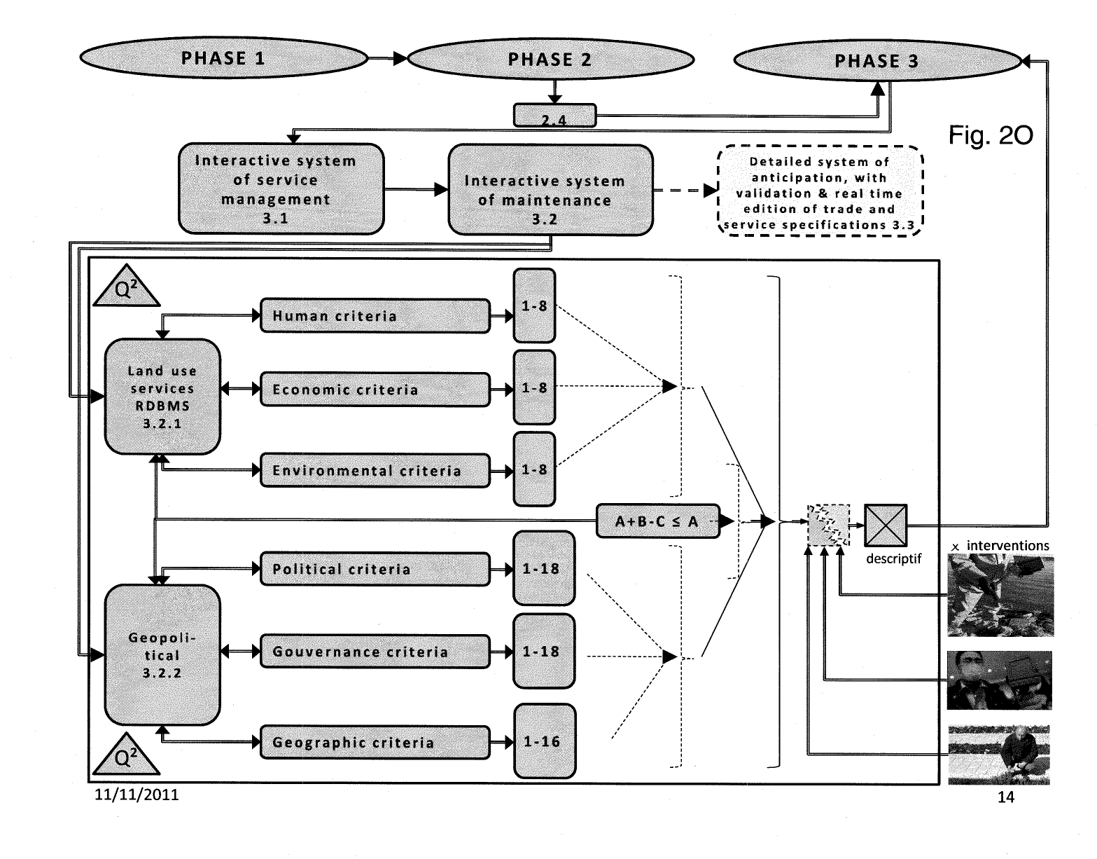

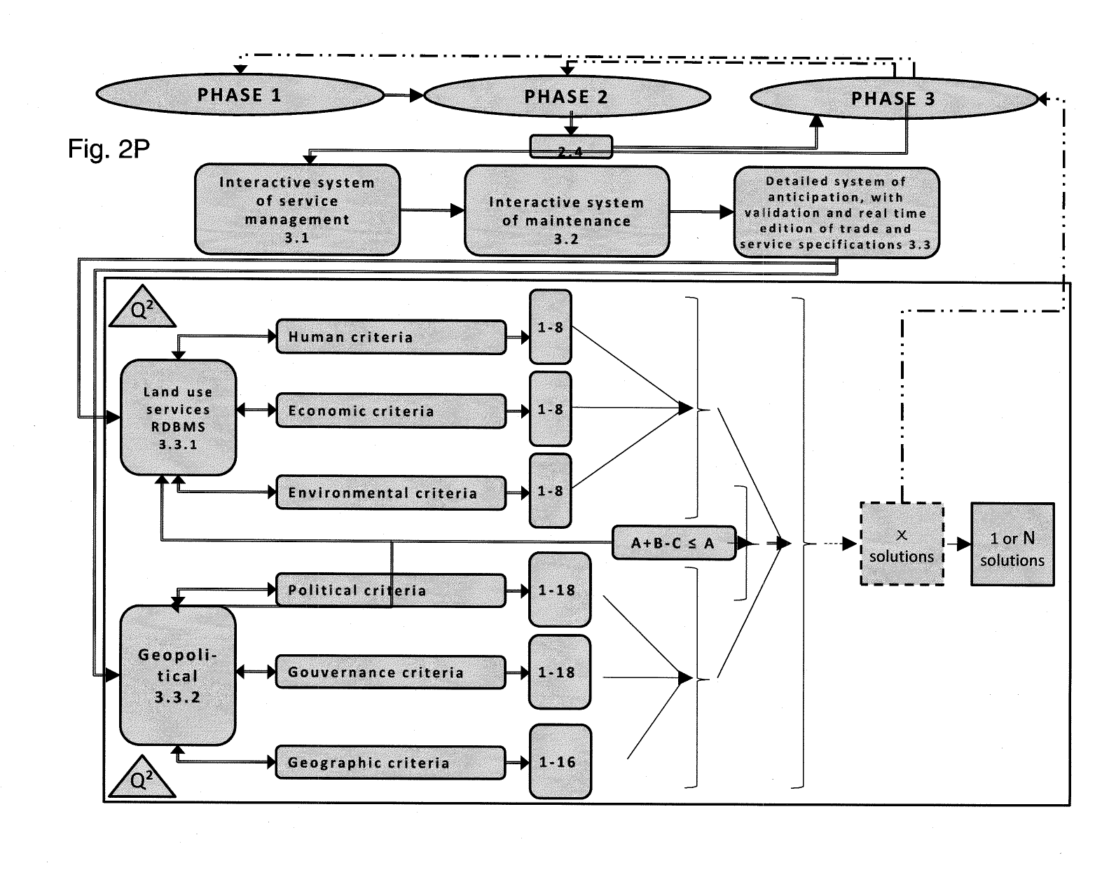

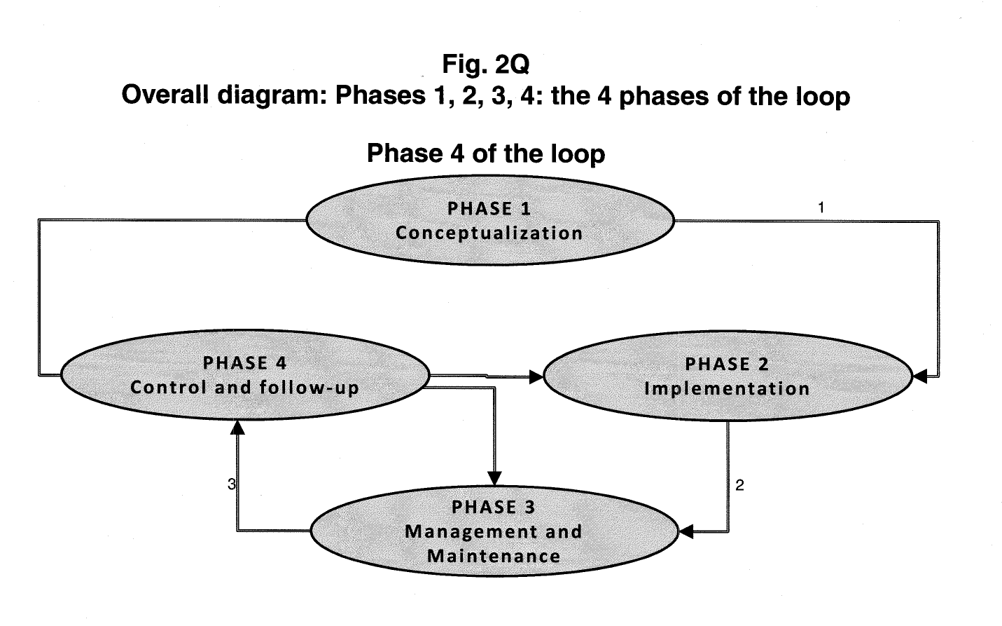

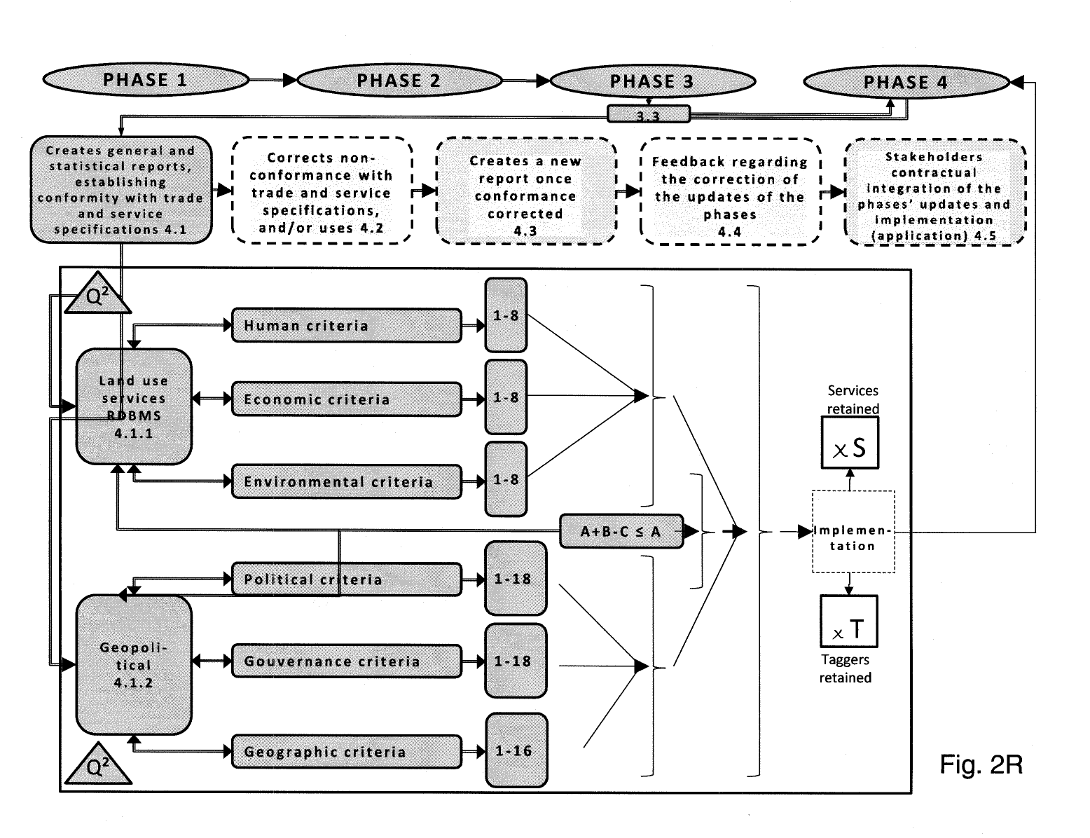

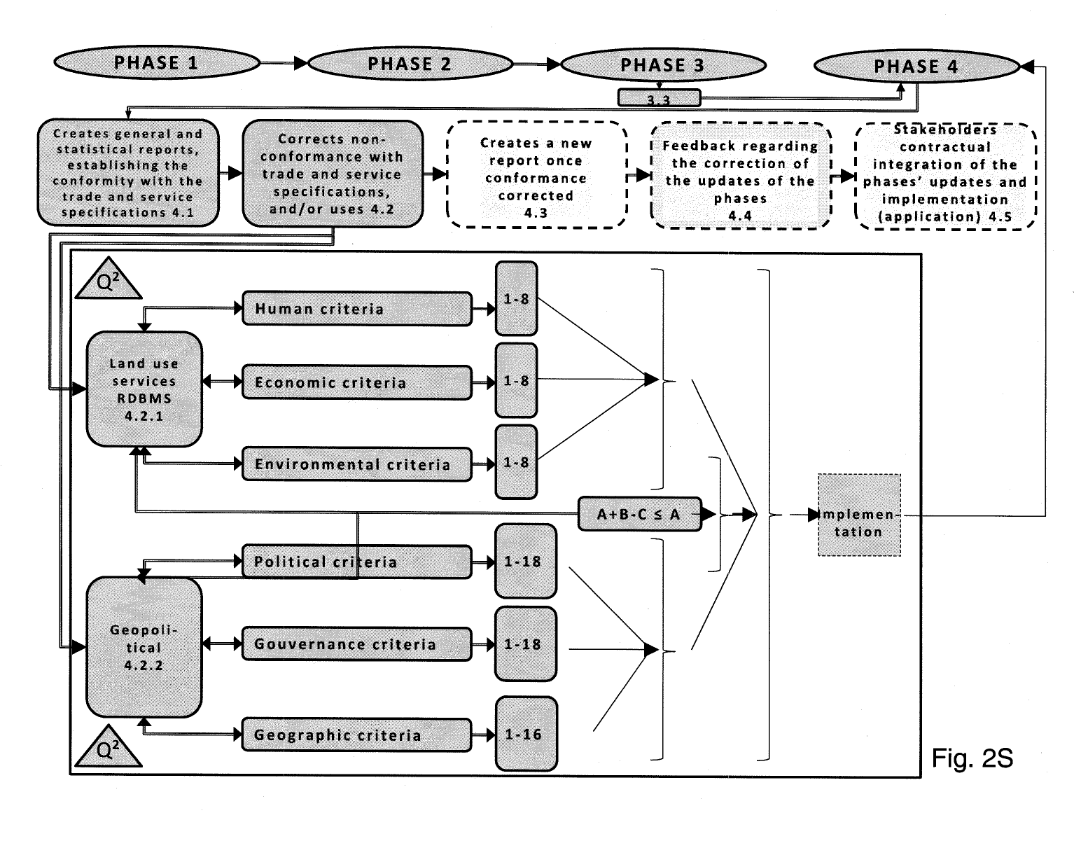

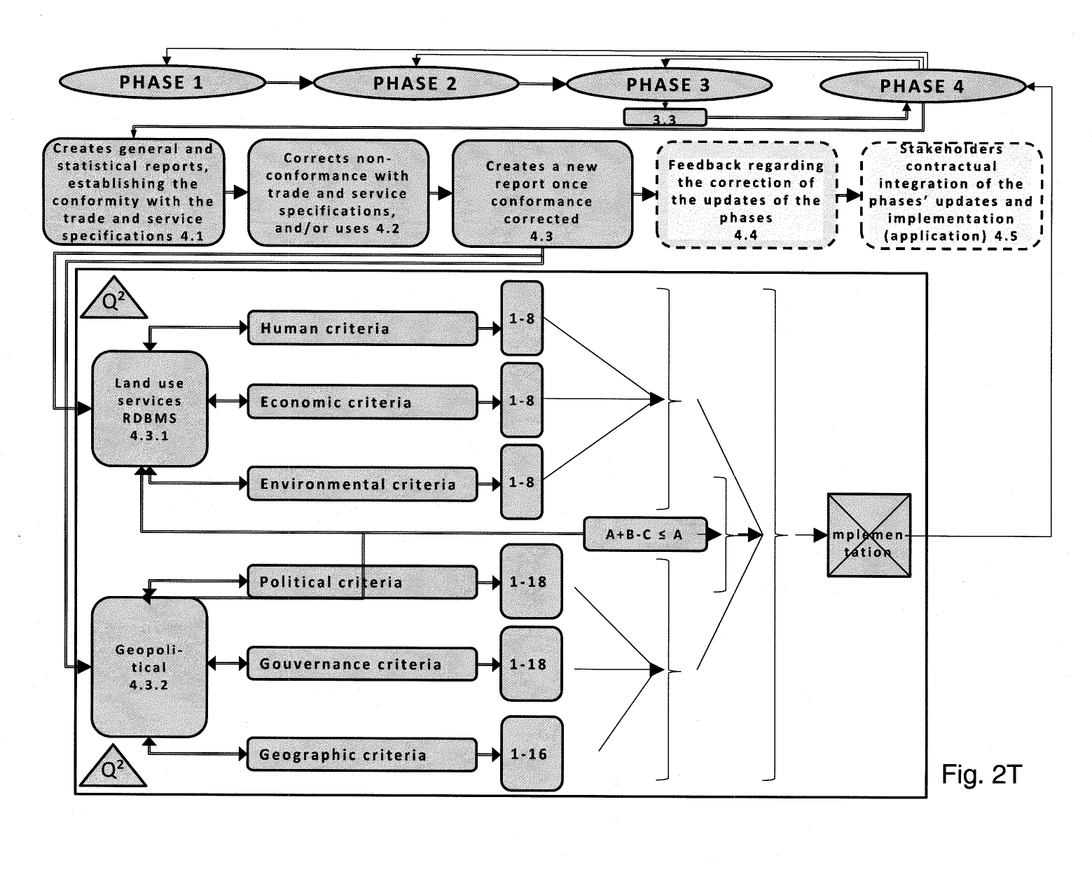

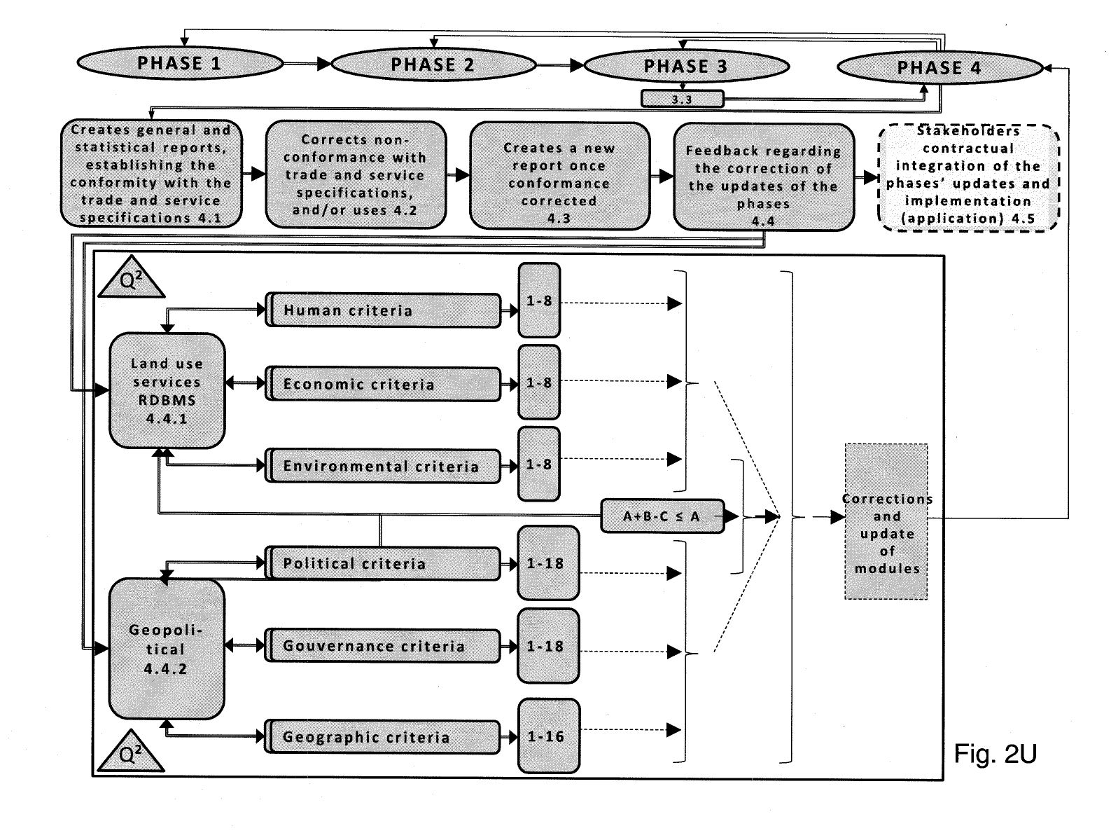

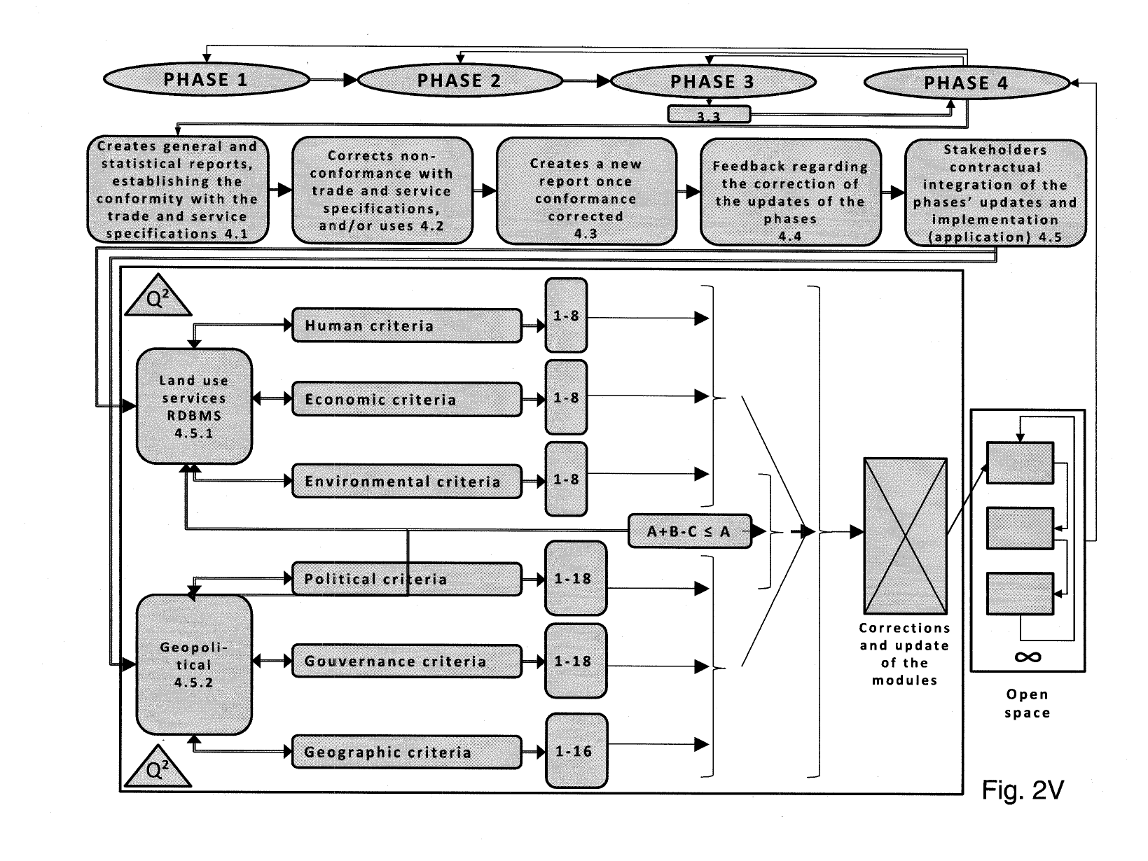

FIG. 2A provides a high-level overview of the operation of a community plan management system according to embodiments of the present disclosure. As shown in FIG. 2A, the system may be configured in some embodiments to operate upon the community plan (200) in four phases: Development or Conceptualization (202), Implementation (204), Management and Maintenance (206), and Control and Follow-up (208).

During Development or Conceptualization (202), a plan is developed and conceptualized to determine the use for a portion of the land within the community. For example, the land may be used for residential, commercial, office, or a combination thereof. In the making of these decisions during the conceptualization phase, many factors must be considered including human, environmental, and economic factors. These factors may also be interrelated. For example, environmental factors can have a direct impact on quality of life for humans living in the affected area. In addition, economic factors may also play a role in future planning of land use and development. System operations in the development portion may include generation of a comprehensive plan.

During Implementation (204), implementation of a land use plan impacts many different people and entities in different ways. Examples of such entities may be builders, service providers, and corporate and individual residents. Often times during an implementation phase it has been found that a planned use must be modified. Therefore, the system must be capable of determining during Implementation (204) the impact that certain changes may have upon a planned land use outcome of Development and Conceptualization (202). System operations in the implementation phase generally include trade specification generation, the construction of the necessary infrastructure and superstructure to support the plan, and the implementation of the physical as well as non-physical elements.

Once Implementation (204) has been completed by, for example, building or constructing the planned infrastructure, the system continues to operate on the plan during Management and Maintenance (206). During this phase, needs for services will change over time. For example, a certain environment may become more dependent upon business development and less dependent upon residential use. Changes in the demographics may require changes in services that are provided. Other changes may include air quality, transportation needs, lighting, accessibility to food, etc. Therefore, during Management and Maintenance (206), the system must be capable of analyzing the changes in services and/or infrastructure needed by the public in the geographic area covered by the plan. System operations in the management phase generally include changes or modifications to trade specifications, construction specifications, and other aspects of the plan.

During Control and Follow-up (208) phase, the system continues to monitor the use of the land, the effectiveness of the services provided, and the quality of life of those who live and/or work in the environment impacted by the plan. The system can monitor, correct, verify conformity, and receive responsive feedback from those who live and/or work in the impacted area. During this phase, the system must be capable of correcting services that are provided, based at least in part on the received feedback.

As shown in FIG. 2A, operation of the system may involve sequential progression through the phases, starting in Development or Conceptualization (202) and ending in Control and Follow-up (208). In some embodiments, system operation also includes “feedback” from a later phase to an earlier phase. For example, upon reaching Control and Follow-up (208), system operation may transition to one of the earlier phases 202, 204, or 206, depending on the system operational requirements. Although not shown in FIG. 2A, system operation may include feedback from phases 204 and/or 206 to earlier phases, e.g., phase 202, in some embodiments. As discussed below with reference to FIGS. 2B through 2V, feedback also may occur between modules that constitute a single phase, such as the modules that constitute Implementation (204) or Maintenance and Management (206). Such feedback may provide a “shortcut” path to improving existing services and/or developing new services compared to conventional community planning techniques. As discussed below, feedback may be collected in many forms including physical sensor data, social media activity data, and a combination thereof (e.g., data from location sensors such as GPS receivers, collected via a social media outlet).

In one embodiment an interactive community plan management system is described that can be used for validating implementation of a community plan, managing and/or maintaining of a community plan. The plan management system operates in the midst of real world changes. One of the benefits of the system is the ability to assist with implementation, management and maintenance of an existing community plan. The existing plan is typically computer generated or generated with assistance from a computer and is stored in a relational database. The plan management system has various uses including, for example, validating plan implementation, managing plan changes, handling events which occur impacting the plan, improving the plan using passive and active inputs and feedback, and maintaining the plan as things change in the real world. The plan management system can react to unexpected events including alerting administrators or the public, soliciting human intervention, and accepting human intervention. The plan management system will change or modify outputs such as trade specifications for implementing a plan, as well as providing notifications of changes or suggested changes to a plan.

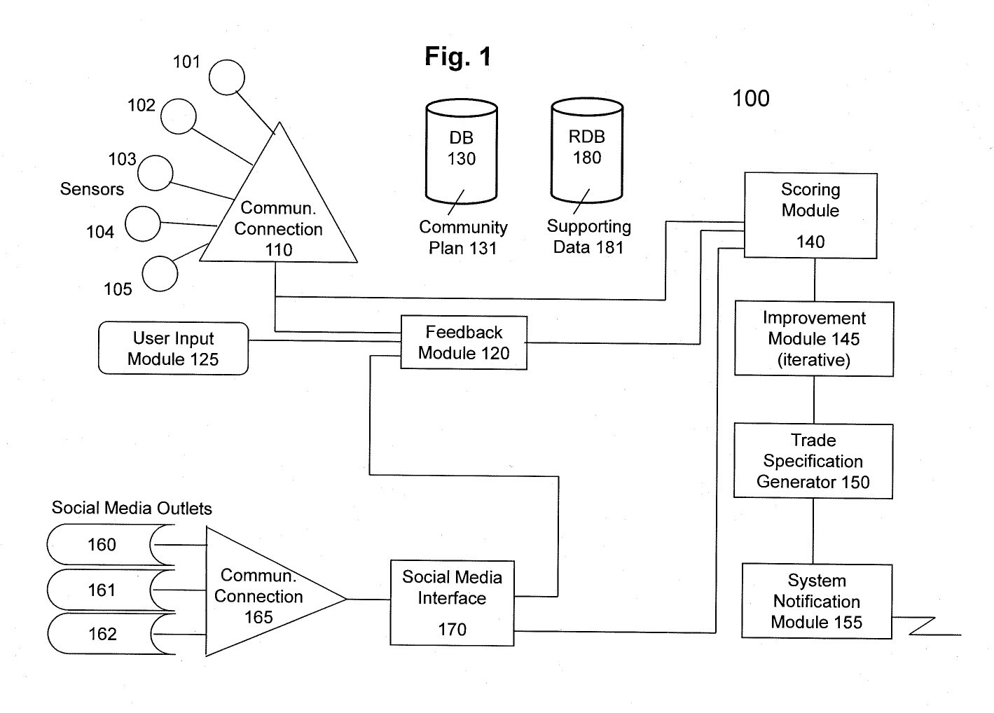

Referring to FIG. 1, a schematic of a plan management system 100 is shown. In one embodiment, the plan management system includes a a database 130 storing a community plan 131, a plurality of sensors 101-105, one or more sensor communication connections 110, a plurality of social media outlets 160-162, a communication connection 165 to the social media outlets, a social media interface 170, a user input module 125, a feedback module 120, a scoring module 140, an improvement module 145, a trade specification generator 150, and a system notification module 155. Sensors 101-105 are preferably connected through sensor communication connection 110. The sensor data may be provided for use by feedback module 120 and/or scoring module 140. In one embodiment, feedback module 120 has a separate input for receiving feedback via user input module 125. For example, feedback module 120 may utilize user input module 125 to send one or more emails requesting feedback on a particular topic or issue (e.g., a questionnaire) to members of the public, and to receive responses to such emails. In another embodiment, feedback module 120 may utilize user input module 125 to publish a web page comprising a feedback form, and to receive completed feedback forms submitted by members of the public.

While social media can be used throughout the planning and management system, social media use may be limited to particular phases, in particular modules of the system, or during particular processes. The system receives social media activity data via a social media interface 170 that is communicatively connected to one or more social media outlets via communication connection 165. Social media interface 170 provides data to feedback module 120 and/or scoring module 140 in a push mode (i.e., initiated by interface 170), a pull mode (i.e., initiated by modules 120 and/or 140), or both. In some embodiments, the system may provide information to one or more social media outlets via social media interface 170 and communication connection 165. In such embodiments, improvement module may be connected to social media interface 170. In some embodiments, one or more of communication connection 165 and social media interface 170 are detachable or can be disconnected.

Scoring module 140 has access to the community plan 131 as stored in the database 130, and interacts directly or indirectly with improvement module 145, trade specification generator 150, and notification module 155. Although shown interconnected in a specific way in FIG. 1, scoring module 140, improvement module 145, trade specification generator 150, and notification module 155 may be connected in various ways and interact with each other in various ways.

Various hardware and software configurations may be used to implement the various portions of the plan management system. For example, each of feedback module 120, social media interface 170, scoring module 140, improvement module 145, trade specification generator 150, and notification module 155 (collectively “system modules”) may be implemented as hardware (e.g., ASIC or programmable circuit), software executed on ageneral-purpose or application-specific processor (e.g., application processor, DSP, etc.), or a combination of hardware and software. To the extent that the system modules are implemented as software, they may be executed on multiple computers or processors that are communicatively and operationally coupled as necessary.

The system 100 can be used to generate a new plan or modify an existing computer-generated plan. The system 100 stores the plan in memory in a database, such as database 130. Supporting data 181 (e.g., sensor data, social media data, and/or scoring module 140 outputs) may be stored in memory or in a relational database, such as relational database 180 shown in FIG. 1. In some embodiments, community plan 131 and supporting data 181 may be stored in a single integrated database, e.g., database 130 or relational database 180. The various system modules of computerized plan management system 100 access the plan 131 and supporting data 181 from memory or one or more databases, as the case may be. Persons of ordinary skill will recognize that the interaction between the system modules and databases 130 and/or 180 may occur in various ways depending on the particular implementation of these components of system 100.

Sensors 101-105 may be deployed to gather data in real-time or with delay (e.g., daily or hourly). Sensor data retrieved with delay can be stored temporarily in the sensor itself or in an intermediate data repository (e.g., cloud storage). Sensors 101-105 may be dispersed in the geographic area associated with community plan 131. Various sensors may be used with the system including audio, visual (e.g., image and/or video), motion, light, temperature, barometric, humidity, wind, seismic, vibration, explosive, radioactivity, chemical, water pressure, pipeline sensors, spill sensors, fluid level (e.g., water), fluid flow (e.g., gas flow or water flow), electrical (e.g., energy usage, overload, etc.), and other types of detectors.

Sensors 101-105 can provide system 100 with data relating to numerous matters, activities, and events including traffic, congestion, crowds, high levels of noise, late night activity, meteorological activities, weather events, construction, power outages, power “brown-outs,” radiation event, spillage or release of oil or chemicals (e.g., via pipeline rupture), earthquake, flood, blockage of storm drains, etc. Based on the sensor readings, the system, typically through the feedback module 120, scoring module 140, and notification module 155 can notify or recommend actions. In some embodiments, the notification module 155 is directly connected to the feedback module 120 and/or the scoring module 140 in order to more quickly provide notification of certain events.

Various communication connections 110 and 165 may be used to connect the various types of sensors 101-105 and social media outlets 160-162, respectively, to the system 100. Exemplary communication connections include wired (e.g., Ethernet), cellular, local wireless (e.g., 802.11), telephony (e.g., dial-up modem), short-range wireless (e.g., Bluetooth, NFC, and/or Zigbee), satellite, and the like. Persons of ordinary skill will recognize and understand that a “communication connection” may comprise a variety of layers according to the OSI model. Moreover, each layer of a connection may comprise an appropriate protocol to communicate between peer entities at each end of a communication connection, e.g., social media outlets 160-162 and social media interface 170. Exemplary protocols include 802.11 PHY/MAC, IP, TCP, UDP, PPP, HTTP, RTP, RTSP, etc., but any technically appropriate protocol known to persons of ordinary skill may be employed.

Based on the sensor input, the scoring module 140 and improvement module 145 may change the plan, recommend changes, make suggestions, or perform other actions. For example, if the sensor data shows that water levels are low and humidity has been low over a period of time, then it may determine that conditions are overly dry over a period of time. Armed with this information the scoring module 140 will score the environmental criteria of water low. For example, based on the latest sensor input showing a seasonal rain shortage of more than six inches, scoring module 140 may determine that the score of the water sub-criteria of the environmental criteria changes from 7.26 (out of possible 10) to 6. In this example, a “7.26” water score represents a normal/acceptable condition and a score of “6” represents a moderately low water condition. This may trigger a change in the community plan to apply certain minimum water conservation measures. This information then in turn causes the notification module 155 to notify system administrators of the recommended change in water policy and to notify the general public of the new water policy including conservation measures.

A similar result could occur if the sensors detect a drinking water pipeline burst or a significant water leak. In real-time, the system can re-score the water sub-criteria and can recommend a new water policy for a certain section or subsection with the planned community. Notifications can be made to the administrator of the system, service or utility companies, the public and to others.

In some embodiments, the plan management system collects social media feedback via the social media interface. The social media feedback can be collected in real-time or non-real-time (e.g., delayed) from various social media outlets via communication connections 165 and social media interface 170. Based on the collected sensor and/or social media, the system can update the plan in real time. The system uses the social media interface 170 in primarily two ways: to obtain feedback on the plan, its implementation, or proposed changes; and to obtain data about the community, environment, and/or the associated geographic area. The plan management system obtains social media feedback and/or community data actively, passively, or by a combination thereof. Whether actively soliciting data or passively monitoring, analyzing or learning from social media, the plan management system must be connected to social media outlets and interpret the data as necessary. Communication connections 165 are used to connect the social media interface 170 of the management system to social media outlets. Internet or other types of communication connections are typically used. Examples of social media outlets include, but are not limited to, Twitter, Facebook, Google Plus, blogs, YouTube, LinkedIn, MySpace, myLife, LiveJournal, Tagged, CafeMom, and Badoo. Other social media outlets available now or in the future may be used.

The social media interface 170 is used to collect, process, analyze, and/or otherwise use the information collected from social media outlets. Both active modes and passive modes of operation may be used with the social media interface.

In active operation, the system solicits responses to particular community issues or topics via the social media interface 170. The plan management system will analyze solicited responses on a particular issue or topic as well as general comments, “tweets,” and blogging on that topic. Exemplary active mode topics may include trash pick-up, water quality, noise, location of public facilities, proposed road improvements, etc. For example, the system may solicit social media feedback by posting via social media interface 170 (e.g., on a blog) questions such as: (a) “Are you willing to pay a toll to have a street built?” (b) “The parking garage at the train station is often full on regular work days. Are you willing to pay for additional parking if it were offered at a premium price?”; (c) “Are you willing to park at a satellite parking lot for the train station if the fee is reduced?”; (d) “Will a start-up company incubator in the XYZ part of town attract new companies to the community?”; and (e) “Will companies utilize ‘Class-A’ office space if it were constructed in this particular area of town?” The plan management system, via the social media interface 170, will collect responses to such questions and use the information for to change or to recommend change to the plan, as the case may be.

In a passive mode, the system utilizes various algorithms to screen or analyze social media to derive information about a community and its members. The algorithms search for key words or phrases; measure amount of traffic on a topic; and measure the popularity of activities, public services, or commercial entities (e.g., stores, coffee shops, public utilities, libraries, public buildings, or services). Popularity may be measured by the amount of “chatter” or the number (or ratio) of likes and dislikes. The plan management system uses social media tracking, monitoring, listening, and engagement tools. Based on the ability to understand and gain insights on community through social media measurements, metrics, sentiments, and analytic reporting, the plan management system may adjust plan implementation, management, and/or maintenance. For example, the system may make plan adjustments based on social media activity about the lack of parking at the town's annual holiday festival, the poor customer service by a public utility company, or the lack of computers at the public library.

Some specific tools the various embodiments of the plan management system may use to derive social media data include: keyword search tools, influence finders, blog monitoring, conversation monitoring, “tweet” monitoring, search results monitoring, multimedia monitoring, brand and buzz monitoring, automated sentiment, key influencer tracking, geographic analytics, demographic analytics.

While the information gathered or derived through social media can be categorized as qualitative and quantitative, metrics and/or values may be computed for both categories. Various measurement and/or analytic tools may be used to compute the social media metrics. In some embodiments, the social media metrics are computed as numerical values or ratios based on the collected social media data. Various metrics may be used including, for example, volume per time unit (e.g., 24 hours), volume rate of change, reach, audience size, engagement, influence, conversation rate (e.g., number of audience comments or replies per post), sentiment tracking, passion, strength, applause rate, and amplification.

The metric “amplification” may have a different meaning when used in the context of different social media outlets. For example, on Twitter, amplification may refer to the number of re-tweets per tweet; on Facebook or Google Plus, amplification may refer to the number of shares per post; and with respect to a blog or YouTube, amplification may refer to the number of share dicks per post (or video). Likewise, the “applause rate” metric may have a different meaning depending on the social media outlet. For example, on Twitter, applause rate may refer to the number of times a post has been identified as a “favorite,” a “like,” or a “+1” on Twitter, Facebook, or Google Plus, respectively. Similarly, with respect to a blog or YouTube, applause rate may refer to the number of times a post (or video) has been identified as a “like” or a “+1”.

The plan management system may further analyze the computed social media metrics or the collected social media data. The analysis of collected social media data may include deriving values and/or ratios that are examined by the management system. Based at least in part on this analysis, the system may determine a scoring for one or more criteria, sub-criteria, or elements, as discussed in more detail below. Moreover, based on this scoring, the system may suggest, recommend, or initiate an action. The action or recommendation may relate to a portion of a community plan.

In some embodiments, the system includes setting thresholds related to one or more sub-criteria or elements within a criterion, and setting triggers for actions to occur (or cease) upon reaching one or more thresholds. Thresholds may be set for social media activity or sentiment as measured by the social media metrics. Thresholds may be specified relative to a mean or median value, relative to a statistical distribution (e.g., two standard deviations above or below the mean), as a rate of change, etc. For example, if the social media volume per day on a topic exceeds a certain threshold, the system may be triggered to initiate a particular action or to cease an ongoing action.

While single thresholds for a metric are used in some embodiments, other embodiments may utilize a series of thresholds for a particular metric, with a different action suggested, recommended, or initiated (ceased) upon reaching each threshold in the series. Thresholds may be set for metrics related to individual sub-criteria or elements, or for a combination or function of metrics related to multiple sub-criteria or elements. For example, if the combination of the reach and sentiment tracking metrics exceeds a threshold or the combination of the passion and strength metrics exceed a threshold the system will be triggered. By way of further example, the system can also be configured so an action is triggered upon both the passion metric and the strength metric reaching individual thresholds. As noted above, thresholds can be set based on various functions of individual metrics, and triggers can be set based on various logical combinations of two or more thresholds. Moreover, various actions may be taken in response to a trigger, including notifying system managers, administrators, or the public; initiating a campaign to obtain feedback; modifying or updating a trade specification; recommending or suggesting a change to the plan; etc. Real-time notifications may be triggered during an emergency or crisis.

As discussed above, collected social media data may be used during the implementation, management, and/or maintenance of a community plan. The plan management system can use the collected social media activity data or the derived data and metrics dynamically (e.g., real-time) or on a delayed basis. Depending on its type and importance, social media data can be used to inform, guide, enlighten, conceptualize, and/or develop future projects, thereby allowing the system to become a learning organism and environment. In some embodiments, the processing of the collected social media activity data and the generation of the various metrics may take place in social media interface 170 of FIG. 2A. In other embodiments, some or all of the processing of the collected social media activity data and the generation of the various metrics may take place in feedback module 120 of FIG. 2A. For example, feedback module 120 may combine a portion of the collected social media activity data and/or the generated metrics with collected sensor data before providing this information to scoring module 140.

Following is a hypothetical example of the plan management system being used to address the availability and use of parking for a new train station being built. In this example, the system utilizes both active and passive monitoring of social media activity. In other embodiments, either active or passive monitoring may be used. In this example, the system calculates metrics for conversation, amplification, and applause for both active social media interactions and passive social media interactions. Specifically, for active social media activity the system calculates “conversation” based on the number of audience comments or replies per post; “amplification” based on the number of re-tweets per tweet on Twitter, the number of “shares” per post on Facebook and Google Plus, and the number of “share” clicks per blog post or YouTube video; and “applause” based on the number of positives or likes per post (or video).

Continuing with the example, the single threshold for the “conversation” metric is set at 10, such that if the number of conversations is greater than 10, the system is triggered to take action. The single threshold for the “amplification” metric is set at 8, such that if “amplification” is greater than 8 the management system is triggered to take action. The single threshold for the “applause” metric is set at 12, such that if “applause” is greater than 12 the system is triggered to take action. Finally, the system is also triggered to take action if the combined total of conversation, amplification, and applause is greater than 24. In this example, the same or similar thresholds are used for the passive social media metrics. Further, the system can also be triggered to take action if the total of the combined active metrics and the combined passive metrics reaches a threshold of, for example, 30.

In the example, the system is also triggered to take different actions depending on the number of thresholds reached. If a one threshold is reached, the system is triggered to generate a recommendation for a user (e.g., an administrator) to review the collected social media activity. Relevant portions of the social media traffic are made available to the system user. If two thresholds are reached, the system is triggered to recommend a review of the social media and to generate an internal report regarding the issues raised with the parking solution at the train station. If three or more thresholds are reached, the system is triggered to recommend scheduling a public hearing about the parking solution in addition to the previous actions. Alternately, if there are particular options available for addressing an issue, the system can recommend changing to—or further study of—a preferred option inferred from the collected social media data and/or computed metrics. Moreover, reaching one or more social media related thresholds can trigger the system to invoke the improvement module in order to find a solution that is more desirable by the community, e.g., by collecting additional social media activity data and rescoring metrics for one or more sub-criteria and/or elements at issue. In this manner, the community plan's parking or transportation may be recommended for change by the system.

In other embodiments, the social media metrics may be calculated on a per day or per week basis, and trends may be analyzed as part of the process. In sum, the system may adapt or change the plan based on community feedback via social media outlets.

Social media feedback may be used to improve the community plan regardless of the phase. Feedback may be provided, for example, during the implementation phase or the design phase. Feedback may be used as a “shortcut” between phases, relative to the traditional community planning process. Feedback may be processed in real time; however, any such processing should take into account the reliability of any real-time data and, preferably, take steps to ensure reliability. For example, more reliable social media data may be obtained by “staging” or soliciting feedback with specific, well-designed questions, games, etc. rather than relying on “raw” or impulsive feedback, which may be over-dramatized due to misinformation, misperceptions, etc. Filters may be used to sort out responses that are irrelevant, intentionally misleading, etc.

The scoring module 140 as described below in detail scores land use services and/or geopolitical criteria. This scoring module 140 may be invoked during various phases or uses of the plan management system. The scoring module 140 is typically used to score the community plan or changes to the plan. For example, if a plan scores low in air quality the system can suggest changes to the plan to improve air quality. The system can also focus the managers or users on the criteria of the community plan having the lowest scores.

In one embodiment, the social media metrics are passed onto the scoring module and are used in scoring the various criteria. The social media activity data or metrics form a portion of the community plan scoring for a particular criterion.

The system can iteratively improve a community plan. As described below in more detail, the improvement module 145 causes the system to recalculate or re-score a plan iteratively to achieve a different or better result. The re-scoring results in changes to the plan itself or implementation, management or maintenance of the plan. This recalculating or rescoring can also occur as a trigger in response to a social media threshold being met.

The improvement module 145 can be initiated in response to a threshold reached, allowing the system to initiate an improvement to the plan in based on social media by the public. The improvement module 145 also can be initiated by request of a user, or upon a scheduled review.

As described below in more detail, the trade specification generator 150 generates vendor and/or contractor plans or specifications for sourcing, implementation, modification, or construction related to the community plan. The trade specification generator 150 is invoked when changes to the plan or the desire of the community suggest or require modification to vendor specifications. A change or other request can cause the trade specification generator 150 to issue modification to specifications.

The notification module 155 notifies individuals of changes or activities of the plan management system. Notifications may be made in various ways including, text, e-mail, phone calls, through social media outlets, or by paper or other tangible medium. Various social media engagement tools may be used by the notification module 155 to inform the public about changes or activities. The notification module 155 also may initiate a social media campaign to seek further public comment and feedback that will be used by the plan management system.

In the following description, an “entity” contracting with a provider of the system described can be defined as “public,” “private,” or “prospective,” the latter of which refers to an internal initiative with the objective of making a proposition to public or private or public/private entities.

In some embodiments, the criteria used by the system for evaluation and actions upon the plan during the four phases can be broadly categorized as “services” and “taggers.” Each of the “services” or “taggers” criteria may comprise multiple sub-criteria, and one of more of the sub-criteria may comprise multiple elements. Taken together, the collection of “services” and “taggers” represent all the factors deemed important for influencing the life cycle of the plan via operation of the system. Although many of the various “services” and “taggers” represent or are associated with intangible features, abstract concepts, etc., the system collects tangible data and quantitatively computes metrics that can be used in complex, quantitative algorithms during system operation. In some embodiments, the quantitative data associated with “services” and “taggers” are stored in a database, such as relational database 180 shown in FIG. 1.

“Services” include tangible and intangible parameters that are associated with land use, including facilities, equipment, services, content, activities, amenities, operations, etc. provided by a municipality, as well as taxes, fees, costs, etc. needed to provide the same. “Services” also may be associated with natural features and conditions, as well as characteristics of the population. Moreover, “services” also may be associated with private facilities, equipment, services, content, activities, operations, etc. inasmuch as they are part of the collective environment. Bridges, schools, a river, streets, streetlights, apartments, TV channels, agriculture, public health, a building, city hall, sports, libraries, a field, offices, a forest, air and water quality, noise, a factory, a lake, a hill, population demographics, etc. are considered as service parameters. In some embodiments, population characteristics such as spirituality, faith, and religion are indirectly included in “services” by their tangible expressions such as a church, a temple, and synagogue.

In the following description, “services” are broken down into three different categories or criteria: human, economic, and environmental. The “human” criterion is further subdivided into the following eight sub-criteria:

### 1. Land-use, Sustainable Development, and Harmonious Development

### 2. Environment and Climate Evolution

### 3. Security

### 4. Information and Communication

### 5. Education

### 6. Health

7. Cultural life, Religious life, Sport

### 8. Transport

Likewise, the “economic” criterion is further subdivided into the following eight sub-criteria:

### 1. Studies and Projection Cost

### 2. Implementation Cost

### 3. Cost of Debt

### 4. Management, Maintenance and Control Cost

### 5. Taxes Revenues

### 6. Yield and Appropriation

### 7. Sale Price of Services

### 8. Legal & Miscellaneous

Finally, the “environmental” criterion is further subdivided into the following eight sub-criteria (where “Q²” refers to quantity and quality):

### 1. Q² Water

### 2. Q² Air

### 3. Q² Noise Level

### 4. Q² Soil-Underground—Relief

5. Q² Green spaces

### 6. Q² Public Lightning

### 7. Q² Waste & Treatment

### 8. Q² Pollution

“Taggers” include tangible and intangible parameters that are associated with geopolitics. For example, “taggers” may be associated with or represent individual and/or collective data such as spirituality or faith; collective data at a social level (e.g., legislation or opinions concerning common issues for the public); rights and obligations of the public (e.g., voting rights, religious rights); interactions or connections among members of the public (e.g., sense of community); effect and/or response to significant environmental and/or political events, influences, etc. originating outside the municipality (e.g., global warming); and regional, continental, planetary, factual data (e.g., geographic information systems (GIS) or maps). Compared to “services”, “taggers” may are more loosely reflected in social media activity data or feedback, and therefore may require more variety of social media activity data—both in amount and in type—to ascertain. Moreover, many “taggers” are associated with parameters that change slowly with time, so social media activity data may need to be collected over longer periods of time to detect trends.

In the following description, “taggers” are broken down into three different categories or criteria: political, governance, and geographic. The “political” criterion is further subdivided into the following 18 sub-criteria:

1. Legal and regulatory society, religious rights, traditional laws,
2. Population, role of women, elders, handicapped, children
3. Technology, sciences, research, ethics
4. Tolerance and fight against inequalities
5. Security risk prevention, civil rights, corruptions and sanctions.
6. Private sector, public sector
7. Agriculture including fishing and agricultural industries.
8. Strategic sources of supplies and storage.
9. Services, business, virtual sphere.
10. Education, training, universities, digital culture and level
11. Economy, private debts, public debts, financing.
12. Information, communication, web.
13. Military, geo-strategy, armament, intelligence, diplomacy, peace
14. Pollution, waste reprocessing, treatment, recycling.
15. Arts, leisure, tourism, sport.
16. Transports: land, sea, air and space
17. The built environment, infrastructure, superstructure.
18. Balance, pace of life, urgency

Likewise, the “governance” criterion is subdivided into the following 18 sub-criteria:
1. Society's usage adaptability implementation
2. Power, hegemony, influence, ethics.
3. Community belonging, national identity, homogeneity, equity.
4. Preventive security, right of interference, war, terrorism, mafia.
5. Current and potential resources.
6. R&D levels and exchanges, intellectual property rights,
7. Community, migration, welcoming, integration, rejection.
8. Economic balance and financial tools.
9. Incompleteness of the institutions, international organizations
10. Incentive towards international regulations, environmental interconnection, biodiversity awareness, means for implementation.
11. Health, medicine, surveillance, pandemics, pharmacopeia, birth and mortality rates.
12. Solidarity, volunteering, working hours and remuneration.
13. Religion, sects, philosophical clubs, networks.
14. Non-transferable zones
15. Nuclear development, supply, waste management, sustainability
16. Aerial, stratospheric, sub-stratospheric
17. Maritime, territorial waters, international waters.
18. Implementation of inter-community charts.

Finally, the “geographic” criterion is subdivided into the following sixteen sub-criteria:
1. Graphic representation, old and current maps, atlas, corem
2. Solar cycles, solar irruptions.
3. Evolution of magnetic direction of the earth.
4. Evolution of the cooling of the core of the earth.
5. Techtronic plates movement, seismic, volcanic activities, tsunami
6. Earth, oceans, underwater, air, wind space at the human level.
7. Meteorology, Climatology, cold, hot and temperate zones.
8. Albedo, Venturi reaction, precipitation, evaporation, light, electromagnetic radiation, lightning
9. Water resources, total soil water potential, network, retention
10. Water: tables, rivers, rain, drinkable saline, brackish, streaming,
11. Climate evolution, consequential geographic phenomenon.
12. Evolution of natural disasters: nature, frequency and amplitude.
13. Soils, minerals, cultivated areas, fertile areas, sterile areas.
14. Primary forest, secondary forest, deforestation, reforestation.
15. Urban areas, suburban areas, rural areas, littoral, deserts, intermediary areas, natural fauna area, floristic.
16. Population areas, agriculture, hoarding, industry, carbon footprint, greenhouse gas emission, geothermic, photosynthesis, phytoplankton, zooplankton.

Terms used with individual “services” or “taggers” can different meanings depending on its context, including its hierarchy among criteria, sub-criteria, elements, etc. Two examples are the terms “security” and “transport”. In the third sub-criterion within “Services”/“Human”, “security” is used in the context of urban morphologies. The distribution of buildings in a neighborhood plan may lead to extremely dangerous, even lawless areas. This notion of “security” is totally specific and is the subject of many theories of urban safety features, all based on the notion of a homogeneous security chain without weak links. It depends on a way of thinking urban planners call security “passive”. To become “active,” it must be accompanied by human services (e.g. police and emergency services) or associated with digital recognition tools (i.e., biometric identification. On the other hand, as used within the fifth sub-criterion within “Taggers”/“Political”, “security” refers more generally to all risks: natural (all areas) or human (all fields) including floods, earthquakes, air pollution, water or food pollution from pesticide use, national security, etc.

Similarly, as the eighth sub-criterion within “Services”/“Human,” “transport” is used in the context of urban or intercity morphologies, depending on the level of detail and across infra or large superstructures. This concept is based on the principle of “ruptures” and “motions” of humans and materials. From elevators, moving sidewalks, roller blades, bicycles, cars, trucks, bus shelters, to subways, train stations, rails, buses, bus stations, trains, airplanes, airports, etc. On the other hand, the concept of “transport” is totally different when used in the context of the sixteenth sub-criterion within “Taggers”/“Political.” Here it pertains to the flux within a neighborhood, city, region, country, or globally such as the management of a transport system of bus, train, plane, freight etc. Again, to be effective, it must be accompanied by “human” services associated with digital management tools.

Even though some ambiguity may result from a term with context-based meaning, any such ambiguity is removed by expression of the particular sub-criteria or elements employing the term in mathematical form. Usage of equations and algorithms transform the concepts comprising terms such as “security” and “transport” into an unambiguous mathematical model that can be utilized by the computerized system in all phases of operation.

FIGS. 2B through 2V further illustrate the four operational phases of the plan management system described above with reference to FIG. 2A. FIG. 2B is a legend of symbols used in the subsequent diagrams. The individual phases are described in more detail below, and in accompanying FIGS. 2C through 2V, in terms of their constituent parts, referred to herein as “modules.” Each phase can be visualized using any of all the visualization tools, from the more simple to the more sophisticated including virtual reality tools in all of the phases.

Phase 1—“Conception”—FIG. 2C

Module 1.1. “Audit of the Existing”—FIG. 2D

The entity is asked to transmit all the information concerning the site under study. The entity has validated the perimeter as precisely as possible. The timeframe of the project has been set up (i.e.: 5 or 10 years/political mandate over 4, 5 or 6 years/a generation, etc). The necessary parameters concerning the ownership of the project, its integration within a defined political and economic environment are therefore clearly established.

Either the entity already has complete and precise information regarding the 8 criteria comprising “services” and “taggers” or the system provider or a service provider is asked to provide under a separate mission the necessary missing data regarding:

A. for land-use “Services”: human, economic, environmental

B. for geopolitical “Taggers”: political, governance, geography.

After an audit, all the information concerning the project that has been gathered and is needed for its feasibility will directly feed the “Land-Use Services” and “Geopolitical Taggers” relational databases. These are the operational parts of the development system. Land-Use Services” is composed of three criteria: “Human”, “Economic” and “Environmental”. “Geopolitical” (also known as “Taggers”) is composed of three criteria: “Political”, Governance” and “Geographic.”

Module 1.2. “Conceptual Project”—FIG. 2E

A first project is presented that takes into account the Q² relationship of the “Services” and “Taggers” either in a format that is understandable and visualizable by non-professionals, or in a format that uses the system's own digital vocabulary (e.g., organization chart, cubes, etc.).

Solutions can be simulated that will allow the entity to see the consequences of the chosen alternatives and better define its objectives, eventually enlarging the perimeter and/or the timeframe. This will lead to a theoretical model of land-use and geopolitics.

On the database created during the audit and depending on the directives of the project, values will be given to the various criteria comprising “services” and “taggers”, as described above. At this level, “services” can be further categorized with one of these three possible values: S1—known or existing service, S2—optimizable service, S3—future service. In some embodiments, S3 includes conduits for implementing next generation technologies. Likewise, “taggers” can be further categorized with one of these three possible values: T1—known or existing tagger, T2—optimizable tagger, T3—future tagger. In some embodiments, T3—includes conduits for implementing next generation technologies.

Module 1.3. “Optimal Project Formulation”—FIG. 2F

At this level the macro-economic constraint “A+B−C≦A” is integrated to the system. This equation is used for economic evaluation, wherein A represents the cost of existing services, B represents the increased cost due to improving the existing service or services, and C depends on the persons or entities involved. More particularly, C is selected from the set {C1, C2, C3, C4, C5} where C1 is the economy of scale (i.e., savings) realized from the implementation of the new service, C2 is the economy of scale realized from more intelligence in maintenance and/or operation of the service, C3 is qualitative increase in level and number of services, C4 is the economy of scale realized from improvement to services; and C5 is the assurance for the service operator to have a sufficiently rapid return on the investment.

Data is exchanged and crossed between “services,” “taggers,” and constraint “A+B−C≦A” to produce optimizable information. This is an important point since at any time of the calculations, intermediary or final, of a phase, the system may reclassify the solutions based on criteria in any of the categories of the audit and conception phases. The system can extract a fixed image at a specific time of the evolution of the project.

Module 1.4. “Development of Trade and Services Specifications and their Validation”—FIG. 2G

In this module, the fixed image “services” and “taggers” becomes verifiable (i.e., the Q² limits of proliferation of certain types of pollution; % of urban transport exchange and acceptable rate of rupture, etc.) allowing the system to create optimal trade and services specifications. At this level data exchanged based on the choices made in the conceptual phase has reached a level of information with sufficient detail concerning the feasibility of the project that it is possible to create the “Operational Chart”. The “Operational Chart” may be stored in a database and made viewable through pre-defined tools such as computer-generated images, virtual images, “virtual journey”, etc. This “Operational Chart” is formally approved by the entity that chooses either to proceed to Phase 2 or to end the mission, if, the mission was intended only as an overview of a wider “program” or political action.

Phase 2—Implementation Phase—FIG. 2H

Module 2.1. “Request for Proposal/Tender”—FIG. 2I

The regulations concerning public or private entities will legally define the type of RFP and tenders. Whatever the context, the final specifications is established based on the “Operational Chart”. These are sufficiently detailed so as to create the necessary documentation to contract with the appropriate trade. The documentation will identify:

1. the community where the project is located

2. the developers and investor that will intervene

3. the “Services and Taggers” providers who will implement the “intangibles”

4. the users through their representatives (associations/committees, politics/think tanks, etc.) and be based on the scale of the project with all the data concerning all the stakeholders.

It is preferred that all of the four families be satisfied, that the macroeconomic equation be validated by all and that all the Q² equations be balanced. Before contracts are finalized, the responses to the RFP and tenders are compared or confirmed to the “Operational Chart”.

In order to do so, the parameters of the responses to the RFP and tenders are entered in the system using the specific “vocabulary” of the system's calculation tool. All the propositions are verified, from the smaller to the larger so as to satisfy the “object” in its interaction with the other components of land-use and geopolitics.

Module 2.2. “Implementation on Site”—FIG. 2J

The system's development tool is capable of integrating billions of pieces of data, to validate or reject them over long periods of time (years, decades) and over large areas (regions). The project implementation under these conditions is not impossible today. Construction projects including tangible and intangible parameters currently have to be fragmented in order to be implemented and controlled. This fragmentation is the source of dysfunctions in all the areas: technical, economic, sustainable, etc. such as the digging of a tunnel with different areas of connection or implementation of a crude oil distribution network over hundreds of miles. The adequacy between theoretical and actual implementation is one of the major problems that the builders of complex sites. The system's development tool allows the integration of all the elements that pertain to the system.

Module 2.3. “Real Time Validation”—FIG. 2K.

A finite number, however numerous, of sensors are being placed prior to the realization of the material and/or immaterial structures. The implementation of these structures prompts a continuous comparison and validation feedback loop between the theoretical digital data and the data as realized through the Operational Chart and the actual structure.

The sensors are different depending on the elements of the structure. Data captured by the sensors are read and interpreted by the system in a common vocabulary. They are validated or rejected then corrected by system's core, hence by the users of the system, then translated so as to be understood by the representatives of the 4 families of people in short community developers, providers and users concerned. Validation, reject, appropriate corrections are made by the system as described in the diagrams.

Module 2.4. “Real Time Validation Access to the New Data Concerning the New Implemented Site or Structure”—FIG. 2L

Whatever the scale of the project, when the construction project is “delivered” it is crucial that the entity that is the owner of the new realizations have access to the data concerning the new material and immaterial structures before the site is opened. This phase 2.4 is possible thanks to the previous phase (2.3) and concerns the final validation, in real time, of the conformity of the project with the “Operational Chart” even if the chart has evolved over the course of the project within the controlled system.

The “Services” and “Taggers” retained are validated, preferably definitively validated. The “Operational Chart” is produced and validated in its final format to be given to “Developers and Investors”, “Services providers”, “Users” and “Communities” as requested. Module 2.4 is also used to transmit to these four groups of entities the simplified instructions to ensure the contractual processes of delivery and appropriation.

Phase 3 “Management and Maintenance Phase”—FIG. 2M

Modules 3.1. “Interactive System of Service Management” and 3.2. “Interactive System of Maintenance”—FIGS. 2N and 2O, Respectively

The interactive system of management and maintenance has been put in place during the implementation phase (2) in conformity with the “Operational Chart” (1). Traditionally this phase is not implemented upstream. It is planned by the different owners of the material and immaterial structures who generally choose a management, and sometimes a maintenance system only after delivery.

The system has been designed to re-use the tools put in place in the previous phases, such as the sensors as management tools. Data processing of information continues to flow in real time and is used by the system specific management (3.1) and maintenance (3.2) software package, based on the “Services” and “Taggers” Relational Database Management System (R.D.M.S).

Data is processed through the system core and is verified by the system of management (3.1) and maintenance (3.2) in such a way as to ensure that any action taken at the management and/or maintenance levels is in accordance to the parameters of the “Operational Chart”. Therefore the interaction between a “Service” and a “Tagger” stays in conformity with the overall system.

If a failure occurs that had not been planned but is found by the system, the system will produce one or several protocols to resolve the failure. If a failure occurs that had not been planned and is not found by the system but is reported, an outside intervention is requested. This failure is then qualified and quantified and an input is generated to update the system.

Module 3.3. “Detailed System of Anticipation, with Validation and Real Time Edition of the Trade and Service Specifications Application”—FIG. 2P

Any dysfunction either in management or in maintenance and whatever the order of the occurrence creates automatically a new protocol, validated at the specific and at the global level to be corrected, even partially. This system is reinforced by an application that anticipates the dysfunction based on:
1. prior knowledge of the degree of reliability of a “Service” or “Tagger” through time (i.e.: wear-out)
2. taking into account in real time the signals given by the tools put in place
3. the implementation of performance options solutions.

If such is the case the progress and/or improvement of the “Service” or “Tagger” are re-integrated upstream in each of the previous phases, including the conceptual phase to improve the system. The system iteratively reorders the solution through successive feedbacks until an acceptable management and maintenance solution(s) is found (i.e., equilibrium is reached). The core is then reactivated and restarts the actions by queries to the three meshes—macro-economic constraint A+B−C≦A, “Services,” and “Taggers”—then through the operators and finally through the “Services” and “Taggers” as defined by the criteria and parameters. The system generates one or more acceptable management and maintenance solutions.

Phase 4 “Control and Follow-Up”—FIG. 2Q

Module 4.1. “Creates General and Statistical Reports, Establishing the Conformity of all the Stakeholders with the Contractual Obligations of the Trade and Service Specifications”—FIG. 2R.

Here the system creates general and statistical reports, in real time, establishing the conformity of the beneficiary of the “Services” and “Taggers” (4th family) and those that realize and warrant them. This can be done through the same flux implemented during the “Implementation” phase in accordance with the “Operational Chart” (1).

System operations in this phase also include regulating the use over time of the “services” and “taggers” in terms of their adequacy to the contracts between developers, suppliers, users and communities. Moreover, in this phase, the system verifies in real time the respect of the trade specifications for the land-use “services” as well as for the geopolitical “taggers.”

Module 4.2. “Corrects the Failures, Errors, Obsolescence, Rejection of any of the Stakeholders that Diverge from the Contractual Obligations of the Trade and Service Specifications, and/or Uses”—FIG. 2S

The system triggers, either in a coercive way or as a bonus, the interventions that have been planned when the solution was chosen, when it was conceived and retained in phase 1, implemented in phase 2, managed and maintained in phase 3. In this phase, the system also corrects the failures, errors, obsolescence, rejections, etc. of any “Service” or “Tagger” that diverges from the contractual obligations of the Trade and Service specifications, and/or uses.

Module 4.3. “Creates a New Report Once Corrected all Failures, Errors, Obsolescence, Rejection of any of the Stakeholders that Respects the Contractual Obligations of the Trade and Service Specifications”—FIG. 2T

In this module, the system creates a new report based on the correction and/or improvement of the “Service” or “Tagger” from module 4.1 in conformity contractual obligations of the trade, Tagger and Service specifications. The system, while it takes into account the obsolescence and/or eventual rejection of the “Services” and “Taggers” reintegrates the data in the databases of phase 3, 2 and 1 or 2 and 1 in the databases to update the criteria and parameters of the “Services” and “Taggers”.

Module 4.4. “Feedback Regarding the Correction of the Updates of the Phases”—FIG. 2U.

Using the same networks as those put in place in Phase 2, the system in this phase creates a feedback to update the initial data all the way up to the “Conception Phase”. Whether through failures or performances, the system is enhanced in real time and indefinitely.

Module 4.5. “Stakeholders Contractual Integration of the Phases' Updates and Implementation (Application)”—FIG. 2V.

The system creates a constant “open space,” void of any data, intended to receive the benefit of the wealth of information from the failures as well as from the performances. As soon as this “open space” is fed, it will take its place in the process and the system generates a new “open space.”

Three hypothetical examples of operations of the plan management system are provided below. Generally, first steps for operating the system are to identify a geographic area and to gather data. In the examples, an area of land within a city boundary is identified. An audit is performed to gather data about the area of land. Some of the types of information gathered about the land are identified above in the tables and also defined criteria. For example, the data gathered may include geographic, greenspace, waterways, soil type, air quality, pollution, waste treatment, etc. Based on the data gathered during the audit, land-use scores are calculated for three criteria: “human,” “economic,” and “environmental.” Each of the criteria may have one or more sub-criteria, and each sub-criterion may have one or more elements. Metrics may be calculated for various sub-criteria and/or elements on an individual basis, then summed, averaged, weighted, and/or combined according to any known function to arrive at metrics or scores for the three criteria.

The first example relates to water, a sub-criterion of the “environment” criterion. The water sub-criterion is comprised of several elements, including volume of water currently available, water pressure, water quality, and seasonal scarcity (drought) data are analyzed. From the audited data, each element of the water sub-criterion is assigned a number between 1 (lowest) and 10 (highest). For example, current water volume levels are compared to historical water demand data and a value of “8” is assigned based on more the current volume satisfying >80% of highest historic demand. Likewise, current water pressure data is compared to water pressure norms (e.g., of various municipalities in the country) and a value of “8” is assigned based on the current water pressure being well above an average or median value. Similarly, water quality data is compared to acceptable norms (e.g., established by water regulatory authorities) a value of “5” is assigned based on average water quality. Finally, a seasonal scarcity number is determined using historical data for an area or region that takes into account the number of droughts and times when water conservation is required. In the example, seasonal scarcity is calculated as “9” since shortages are extremely rare in the area and it is currently not the dry season.

Next, a score for the water sub-criteria is assigned based on a function of the values assigned for these elements. Any function may be employed, including averaging and/or weighting the individual values. In this example, weights are assigned to each of the individual values with water quality and seasonal scarcity weighted by 0.33, water pressure by 0.17, and current water volume by 0.16. Note that the sum of the weights is equal to 1. Accordingly, the water sub-criteria score is calculated as (0.33×5+0.33×9+0.17×8+0.16×8=) 7.26.

If a water sensor detects a burst pipe and/or other related water data is streaming real-time to the system, the system will automatically recalculate the water sub-criteria. Four thresholds for action are set in the system for the water sub-criteria, with the action triggered upon reaching each threshold being more severe than for the previous threshold. First, if the new water sub-criteria score is 6 or below, or more than a 20% less than the most recent score, then the system is triggered to provide a first-level notification, e.g., to a system administrator. First-level notification also may be triggered if the water criteria score is decreasing at an average rate greater than 5% per day for the past four days. Second-level thresholds may be set at a reduction of 30% from the most recent score or an average decrease of 6% per day during the last five (5) days. Reaching either or both of these thresholds may trigger more severe actions than the first-level thresholds, including suggestions and/or recommendations to address the problem. Likewise, third-level thresholds may be set at a reduction of 40% from the most recent score or an average decrease of 8% per day during the last five (5) days. Reaching either or both of these thresholds may trigger more severe actions than the first- or second-level thresholds, e.g., public notification requesting voluntary water conservation. Finally, reaching a fourth-level threshold may trigger actions including, but not limited to, automatic water conservation, shutoffs, and/or high-level alerts to the administrators and/or to the public. Typically, the fourth-level threshold would be reached if immediate water shut-offs, severe shortages, or severe pressure decreases were about to occur; if water quality fell below acceptable government standards (e.g., due to contamination); or upon other catastrophic event impacting the water supply. A similar, multi-threshold regime could be employed for other water-related parameters, such as water quality.

The system also can take such actions based partly or entirely upon social media activity and metrics derived therefrom. If one or more social media metrics change or meet certain thresholds as described above, the rescoring can cause notifications or other actions, depending on the triggers associated with the particular thresholds.

The rescoring will follow the procedure described above. For example, each element of the water sub-criteria is associated with a separate social media metric. The system can be triggered to take action if, for example, a social media metric associated with water pressure (e.g., water pressure complaints or problems noted on social media and/or other social media metrics described herein) exceeds the short- or long-term average for that metric by particular threshold amounts, such as by 15%, 30%, 50%, and 80%. For example, exceeding a first-level threshold (i.e., by 15%) may trigger a notification of the system administrator of a possible water problem and provision of the related social media activity for review. As described above with respect to the four-level thresholds for sensor data, exceeding higher social media threshold levels can triggers action that are more severe than actions triggered by exceeding lower-level thresholds, such as additional notifications.

Furthermore, a decrease in the score for the water sub-criteria may cause a decrease in the overall score for the environmental criteria which may initiate other responses or reactions from the system. In the example, environmental has eight sub-criteria which may be weighted or averaged to form the environmental criteria score. Water is just one of the eight sub-criteria which are calculated for the overall environmental score.

For example, the eight environmental sub-criteria may be equally weighted at 12.5% to arrive at an environmental score between 1 and 10. The environmental score may then be used to make determinations on a community plan. The scores from the various criteria such as human, economics and environmental are then summed, averaged or weighted to develop overall scores for a plan or a specific implementation of a plan. Similarly, for the geopolitical picture, scores for politics, governance and geographic criteria may be used to assess a proposed, implemented or amended plan. Land-use and geopolitical scores also may be analyzed and combined.

A second example relates to availability of electricity or other forms of energy (e.g., electricity). The available of energy will impact a number of sub-criteria. Therefore, sensor data on electricity or social media data on electricity can cause rescoring in a number of sub-criteria such as security, transport, communication and public lighting. Each of these rescoring can occur as described with regard to water. Thus, the system can react to “brown-outs” (lower power) and power outages by transmitting real-time notifications to members of the public in the affected geographic area. In some embodiments, the notifications may comprise requests or demands to reduce electrical consumption during a brown-out or outage, as the case may be.

A third example relates to emergency services, in particular first responders in the event of a disaster such as an earthquake, flood, tornado, etc. In some embodiments, the system may collect information from sensor networks deployed by other organizations, such as the National Aeronautics and Space Administration (NASA) Real-time Earthquake Analysis for Disaster (READI) Mitigation Network that provides advanced warning of large earthquakes in the western United States. In some embodiments, the system also may utilize new social media tools to collect real-time social media information such as the location and conditions of residents in the area affected by the disaster, so as to best direct first responder resources. For example, the system may collect data via a social media outlet comprising an interactive mapping application whereby individuals can post photos and descriptive information that is linked to their current geographic location. Such an application may be based, for example, on the Ushahidi platform (http://www.ushahidi.com/products/ushahidi-platform) that is known to persons of ordinary skill in the art.

The system may integrate the data collected from sensors deployed by the municipality itself and by other organizations (e.g., NASA), as well as from various social media outlets, to provide real-time notifications and initiate other actions such as those described above. For example, the system may provide real-time notifications to residents to avoid certain geographic areas or locations where the event is taking place. Likewise, the system may provide real-time notifications to first responders detailing locations where their assistance is required, e.g., via the municipality's emergency dispatch system.

The inventions set forth above are subject to many modifications and changes without departing from the spirit, scope or essential characteristics thereof. Thus the embodiments explained above should be considered in all respect as being illustrative rather than restrictive of the scope of the inventions as defined in the appended claims.

What is claimed is:

1. A computerized, interactive community plan management system, comprising:
a computer-accessible database, configured to store a computer-generated community plan associated with a geographical area, wherein data to support the plan is stored in a relational database and where the community plan is associated with a geographic area;
one or more sensors configured to provide sensor data related to the geographical area;
a feedback module configured to receive electronic communications comprising feedback from a plurality of persons or entities associated with at least one of the geographical area and the community plan;
a scoring module configured to determine scores related to one or more criteria associated with the community plan, wherein the scores are determined based upon the sensor data and the activity data, and wherein the system is configured to utilize the scores in the development, implementation, maintenance, or control of the community plan; and
a system notification module, configured to transmit or display a notification upon the occurrence of a suggested change to the community plan.

2. The system of claim 1, further comprising a trade specification generator configured to generate a trade specification based on the criteria scores determined by the scoring module, and wherein the system notification module is further configured to transmit or display a notification upon the generation of a new or revised trade specification.

3. The system of claim 1, further comprising an improvement module configured to iteratively improve a score for one or more criteria, wherein the feedback module is further configured to solicit information from the public.

4. The system of claim 3, further comprising one or more communication connections configured to receive sensor data from the one or more sensors.

5. The system of claim 1, further comprising:
a social media interface configured to receive activity data from one or more social media outlets; and
one or more communication connections configured to couple the social media interface to the one or more social media outlets.

6. The system of claim 1, wherein the one or more criteria associated with the plan include at least one of the following criteria: land use, human, economic, environmental, geopolitical, political, governance, and geographic.

7. The system of claim 1, wherein the one or more criteria comprise sub-criteria, and wherein the scoring module is further configured to determine scores for the sub-criteria.

8. The system of claim 1, wherein the sub-criteria comprise one or more of Land-use, Sustainable Development, and Harmonious Development; Environment and Climate Evolution; Security; Information and Communication; Education; Health; Cultural life; Religious life; Sport; Transport; Cost of Studies and Projection; Implementation Cost; Debt Cost; Management; Cost of Maintenance and Control; Tax Revenues; Yield and Appropriation; Price Charged for Services; Legal and Miscellaneous; Water; Air; Noise; Soil; Green Spaces; Public Lighting; Waste Treatment; and Pollution.

9. The system of claim 5, wherein the social media interface is further configured to determine one or more social media metrics based on the received activity data, and wherein the scoring module is configured to utilize the social media metrics when determining scores.

10. The system of claim 9, wherein the one or more social media metrics comprise one or more of the following: volume per time unit, volume rate of change, reach, audience size, engagement, influence, conversation rate, sentiment, passion, strength, applause rate, and amplification.

11. The system of claim 9, wherein the social media interface is further configured to receive updates of the activity data at least once per day and to provide updates of the one or more social media metrics at least once per day.

12. The system of claim 9, wherein the social media interface is further configured to receive real-time updates of the activity data and to provide real-time updates of the one or more social media metrics.

13. The system of claim 12, wherein the feedback module is further configured to receive real-time updates of the sensor data, and wherein the scoring module is further configured to update criteria scores in response to at least one of the updated sensor data and the updated social media metrics.

14. The system of claim 13, wherein the system notification module is further configured to generate real-time notifications in response to the updated criteria scores.

15. The system of claim 13, further comprising a trade specification generator configured to update one or more trade specifications in response to the updated criteria scores.

16. The system of claim 5, wherein the social media interface is configured to provide an interactive mapping application for soliciting information from the public related to at least one of the geographical area and the community plan.

17. The system of claim 5, wherein the social media interface is configured to publish a request for public responses on at least one social media outlet, and to collect responses to the published request from the at least one social media outlet.

18. The system of claim 5, wherein the social media outlets comprise one of more of Twitter, Facebook, Google Plus, blogs, YouTube, LinkedIn, MySpace, myLife, LiveJournal, Tagged, CafeMom, and Badoo.

19. The system of claim 1, wherein the sub-criteria comprise one or more of societal economic balance, pace and balance of life, urgency, volunteerism, hegemony, homogeneity, ability to access and exchange information, societal ethics, community integration and belonging, national identity, societal justice and equity, societal tolerance, fear of war or terrorism, influence of organized crime, individual and collective rights, intellectual property rights, rule of law, environmental awareness, recycling propensity, access to health care and medicine, birth and mortality rates, sustainable energy, roles of public and private sectors, and education.

20. The system of claim 1, wherein the one or more sensors comprise four sensors selected from among the following types of sensors: audio, image, video, motion, visible light, infrared light, temperature, barometric, humidity, wind, seismic, vibration, explosive, radioactivity, chemical, water pressure, pipeline, spillage, fluid level, fluid flow, energy usage, and energy overload.

21. A method for the management of a community plan associated with a geographical area, comprising:
receiving sensor data related to the geographic area from one or more sensors;
receiving activity data related to at least one of the geographical area and the community plan from one or more social media outlets;
determining scores related to one or more criteria associated with the community plan, wherein the scores are determined based upon the sensor data and the activity data;
storing information comprising at least one of the sensor data, the activity data, the feedback, and the scores in a computer-accessible database;
utilizing the information stored in the computer-accessible database in the development, implementation, maintenance, or control of the community plan; and
generating a notification for transmission or display upon the occurrence of a suggested change to the community plan.

22. The method of claim 21, further comprising:
generating a trade specification based on the determined scores; and
creating a notification for transmission or display upon the generation of a new or revised trade specification.

23. The method of claim 21, further comprising iteratively improving the score for at least one of the one or more criteria by soliciting information from the public via the one or more social media outlets.

24. The method of claim 21, further comprising determining one or more social media metrics based on the received activity data, wherein the social media metrics are used when determining scores.

25. The method of claim 24, wherein the one or more social media metrics comprise one or more of volume per time unit, volume rate of change, reach, audience size, engagement, influence, conversation rate, sentiment, passion, strength, applause rate, and amplification.

26. The method of claim 24, further comprising receiving updates of the activity data at least once per day and updating the one or more social media metrics at least once per day.

27. The method of claim 24, further comprising receiving real-time updates of the activity data and providing real-time updates of the one or more social media metrics.

28. The system of claim 27, further comprising receiving real-time updates of the sensor data, and updating criteria scores in response to at least one of the updated sensor data and the updated social media metrics.

29. The method of claim 28, wherein the notifications are generated real-time in response to the updated criteria scores.

30. The method of claim 28, further comprising updating one or more trade specifications in response to the updated criteria scores.

31. The method of claim 23, wherein soliciting information from the public comprises providing an interactive mapping application related to at least one of the geographical area and the community plan.

32. The method of claim 23, wherein soliciting information from the public comprises publishing a request for public responses on at least one social media outlet, and collecting responses to the published request from the at least one social media outlet.

33. The method of claim 21, wherein the social media outlets comprise one of more of Twitter, Facebook, Google Plus, blogs, YouTube, LinkedIn, MySpace, myLife, LiveJournal, Tagged, CafeMom, and Badoo.

34. A computer readable medium comprising instructions that, when executed by at least one processor comprising a community plan management system, cause the system to:
receive sensor data related to a geographical area associated with the community plan;
receive feedback from a plurality of persons or entities associated with at least one of the geographical area and the community plan, wherein the feedback comprises activity data from one or more social media outlets;
determine scores related to one or more criteria associated with the community plan, wherein the scores are determined based upon the sensor data and the activity data;
store information comprising at least one of the sensor data, the activity data, the feedback, and the scores in a computer-accessible database;
utilize the information stored in the computer-accessible database in the development, implementation, maintenance, or control of the community plan; and
generate a notification for transmission or display upon the occurrence of a suggested change to the community plan.

35. The computer readable medium of claim 34, further comprising instructions that, when executed by the at least one processor, cause the system to:
generate a trade specification based on the determined scores; and
create a notification for transmission or display upon the generation of a new or revised trade specification.

36. The computer readable medium of claim 34, further comprising instructions that, when executed by the at least one processor, cause the system to iteratively improving the score for at least one of the one or more criteria by soliciting information from the public via the one or more social media outlets.

37. The computer readable medium of claim 34, further comprising instructions that, when executed by the at least one processor, cause the system to determine one or more social media metrics based on the received activity data, wherein the social media metrics are used when determining scores.
